(19) United States
(12) Patent Application Publication
(10) Pub. No.: US 2026/0303308 A1
(43) Pub. Date: Oct. 1, 2026

(54) RAN SHARING AND SBFD OPERATION

(71) Applicant: QUALCOMM Incorporated, San Diego, CA (US)

(72) Inventors: Muhammad Sayed Khairy ABDELGHAFFAR, San Jose, CA (US); Krishna Kiran MUKKAVILLI, San Diego, CA (US); Yeliz TOKGOZ, San Diego, CA (US)

(21) Appl. No.: 19/091,634

(22) Filed: Mar. 26, 2025

(51) Int. Cl. H04L 5/14; H04L 5/00; H04W 16/14; H04W 72/0453

(52) U.S. Cl. CPC H04L 5/14; H04L 5/001; H04W 16/14; H04W 72/0453

(57) ABSTRACT

A method for wireless communication at a first core network and related apparatus are provided. In the method, the first core network receives, from a network node shared with a second core network, a subband full duplex (SBFD) configuration indicative of a first downlink resource and a first uplink resource assigned to the first core network. The first downlink resource and the first uplink resource are located in a component carrier including multiple resources shared among different core networks including the second core network. The first core network further schedules wireless communication for at least one user equipment (UE) via the network node based on the first downlink resource and the first uplink resource.

### TECHNICAL FIELD

The present disclosure relates generally to communication systems and, more particularly, to interference mitigation and spectrum sharing in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first core network. The apparatus may include at least one memory and at least one processor coupled to the at least one memory. Based at least in part on information stored in the at least one memory, the at least one processor may be configured to receive, from a network node shared with a second core network, a subband full duplex (SBFD) configuration indicative of a first downlink resource and a first uplink resource assigned to the first core network, where the first downlink resource and the first uplink resource are located in a component carrier comprising multiple resources shared among different core networks including the second core network; and schedule wireless communication for at least one user equipment (UE) via the network node based on the first downlink resource and the first uplink resource.

In an aspect of the disclosure, a method, a computer-readable medium, and an apparatus are provided for wireless communication at a network node shared by multiple core networks. The apparatus may include at least one memory and at least one processor coupled to the at least one memory. Based at least in part on information stored in the at least one memory, the at least one processor may be configured to provide to a first core network a first indication of a first downlink resource and a first uplink resource assigned to the first core network based on an SBFD configuration, where the first downlink resource and the first uplink resource are located in a component carrier including multiple resources shared among different core networks including a second core network; provide to the second core network a second indication of a second downlink resource and a second uplink resource assigned to the second core network based on the SBFD configuration, where the second downlink resource and the second uplink resource are located in the component carrier comprising the multiple resources shared among the different core networks including the first core network; and exchange communication with at least one UE based on the SBFD configuration.

In an aspect of the disclosure, a method, a computer-readable medium, and an apparatus are provided for wireless communication at a UE. The apparatus may include at least one memory and at least one processor coupled to the at least one memory. Based at least in part on information stored in the at least one memory, the at least one processor may be configured to receive, from a network node, system information block (SIB) including network sharing information for a component carrier between different core networks including a first core network, where the network sharing information indicates a downlink operator subband and an uplink operator subband for the first core network that serves the UE, where the downlink operator subband and the uplink operator subband are located in the component carrier comprising multiple resources shared among the different core networks; and communicate with the first core network based on the downlink operator subband and the uplink operator subband.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A, FIG. 4B, FIG. 4C, and FIG. 4D illustrate various modes of full duplex communication.

FIG. 5 illustrates examples of in-band full-duplex (IBFD) and subband frequency divisional duplex resources.

FIG. 6 is a diagram illustrating an example of subband full-duplex (SBFD) operation.

FIG. 7 is a diagram illustrating various interferences in wireless communication involving multiple operators.

FIG. 8A and FIG. 8B show diagrams illustrating examples of radio access network (RAN) sharing among multiple operators.

FIG. 9 is a diagram illustrating an example of a wide component carrier being shared among multiple operators in accordance with various aspects of the present disclosure.

FIG. 10 is a diagram illustrating an example of a wide component carrier including an uplink symbol and SBFD symbols in accordance with various aspects of the present disclosure.

FIG. 11 is a diagram illustrating an example of a wide component carrier being shared among multiple operators in accordance with various aspects of the present disclosure.

FIG. 12 is a diagram illustrating an example of dynamic subband splitting in a wide component carrier in accordance with various aspects of the present disclosure.

FIG. 13 shows diagrams illustrating an example of sharing a wide component carrier among multiple operators using dynamic time division duplex (TDD) in accordance with various aspects of the present disclosure.

FIG. 14A is a diagram illustrating an example of time division multiplexing (TDM) based RAN sharing of a wide component carrier in accordance with various aspects of the present disclosure.

FIG. 14B is a diagram illustrating an example of a cell ON/OFF cycle based on the sharing of a wide component carrier among multiple operators in accordance with various aspects of the present disclosure.

FIG. 15A is a diagram illustrating an example of RAN sharing of a wide component carrier based on a combined TDM and frequency division multiplexing (FDM) in accordance with various aspects of the present disclosure.

FIG. 15B is a diagram

FIG. 16 is a call flow diagram illustrating a method of wireless communication in accordance with various aspects of the present disclosure.

FIG. 17 is a flowchart illustrating methods of wireless communication at a UE in accordance with various aspects of the present disclosure.

FIG. 18 is a flowchart illustrating methods of wireless communication at a first core network in accordance with various aspects of the present disclosure.

FIG. 19 is a flowchart illustrating methods of wireless communication at a first core network in accordance with various aspects of the present disclosure.

FIG. 20 is a flowchart illustrating methods of wireless communication at a network node shared by multiple core networks in accordance with various aspects of the present disclosure.

FIG. 21 is a diagram illustrating an example of a hardware implementation for an example apparatus and/or UE.

FIG. 22 is a diagram illustrating an example of a hardware implementation for an example network entity.

### DETAILED DESCRIPTION

In wireless communication, a network node (or network entity) may perform subband full duplex (SBFD) operation to enable simultaneous transmission and reception on separate subbands. However, one limitation to the widespread adoption of SBFD operation is the presence of inter-operator cross-link interference (CLI). Since there is typically no direct link or exchange of information between different operators, mitigating inter-operator CLI is difficult, which often relies on techniques such as spatial isolation and/or physical separation. Example aspects presented herein provide methods and apparatus for mitigating CLI in multi-operator environments by utilizing radio access network (RAN) and spectrum sharing, using a single radio unit/distributed unit (RU/DU) shared for all operators.

Various aspects relate generally to wireless communication. Some aspects more specifically relate to interference mitigation and spectrum sharing in wireless communication. In some examples, a first core network receives an SBFD configuration from a network node shared with a second core network. The SBFD configuration indicates a first downlink resource and a first uplink resource assigned to the first core network, and the first downlink resource and the first uplink resource may be located in a component carrier including multiple resources shared among different core networks including the second core network. The first core network further schedules wireless communication for at least one user equipment (UE) via the network node based on the first downlink resource and the first uplink resource. The allocation of the first downlink resource and the first uplink resource in the component carrier may be implemented in different ways. In one configuration, the component carrier may include a downlink carrier subband and an uplink carrier subband for SBFD time resources, and the first downlink resource may include a first downlink operator subband located in the downlink carrier subband, and the first uplink resource may include a first uplink operator subband located in the uplink carrier subband. In another configuration, the component carrier may span across multiple SBFD time resources, and the component carrier may include a downlink carrier subband and an uplink carrier subband on each SBFD time resource of the multiple SBFD time resources. The downlink carrier subband at a first SBFD time resource of the multiple SBFD time resources may be different from the downlink carrier subband at a second SBFD time resource of the multiple SBFD time resources in the frequency domain. The first downlink resource may include a first downlink operator subband located on a first set of SBFD time resources in the multiple SBFD time resources, and the first uplink resource may include a first uplink operator subband located on a second set of SBFD time resources in the multiple SBFD time resources. In another configuration, the component carrier may be shared between the different core networks based on time division multiplex (TDM) across multiple SBFD time resources. In another configuration, the component carrier may be shared between the different core networks based on the TDM across the multiple SBFD time resources and frequency division multiplexing (FDM) within an SBFD time resource.

Particular aspects of the subject matter described in this disclosure can be implemented to realize one or more of the following potential advantages. In some examples, by implementing interference mitigation in shared RAN setups, the described techniques enable effective mitigation of CLI between operators, which is traditionally hard to manage due to a lack of inter-operator coordination. In some examples, by assigning paired downlink and uplink operator subbands to each operator within a large shared component carrier, the described techniques enable full SBFD capability for each operator independently and effective mitigation of CLI between operators. In some examples, by enabling time-domain multiplexing (TDM) and frequency-domain multiplexing (FDM) sharing of a component carrier for multiple operators, the described techniques improve spectrum flexibility and adaptability.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

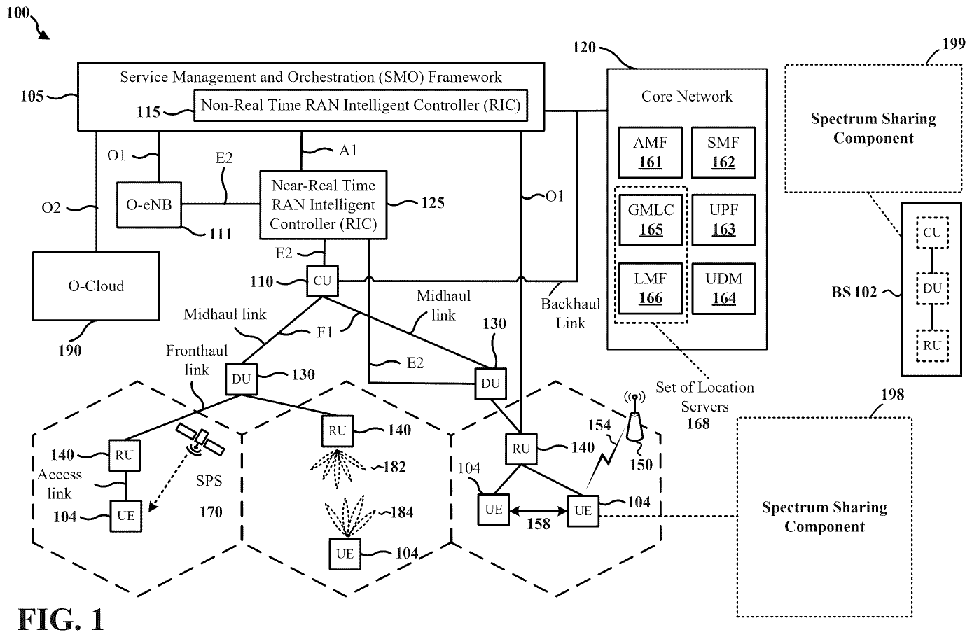

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHz-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the spectrum sharing component 198. The spectrum sharing component 198 may be configured to receive, from a network node, SIB including network sharing information for a component carrier between different core networks including a first core network, where the network sharing information indicates a downlink operator subband and an uplink operator subband for the first core network that serves the UE, where the downlink operator subband and the uplink operator subband are located in the component carrier comprising multiple resources shared among the different core networks; and communicate with the first core network based on the downlink operator subband and the uplink operator subband. In certain aspects, the base station 102 may include the spectrum sharing component 199. In some aspects, the spectrum sharing component 199 may be configured to receive, from a network node shared with a second core network, an SBFD configuration indicative of a first downlink resource and a first uplink resource assigned to the first core network, where the first downlink resource and the first uplink resource are located in a component carrier comprising multiple resources shared among different core networks including the second core network; and schedule wireless communication for at least one UE via the network node based on the first downlink resource and the first uplink resource. In some aspects, the spectrum sharing component 199 may be configured to provide to a first core network a first indication of a first downlink resource and a first uplink resource assigned to the first core network based on an SBFD configuration, where the first downlink resource and the first uplink resource are located in a component carrier including multiple resources shared among different core networks including a second core network; provide to the second core network a second indication of a second downlink resource and a second uplink resource assigned to the second core network based on the SBFD configuration, where the second downlink resource and the second uplink resource are located in the component carrier comprising the multiple resources shared among the different core networks including the first core network; and exchange communication with at least one UE based on the SBFD configuration. Although the following description may be focused on 5G NR, the concepts described herein may be applicable to other similar areas, such as LTE, LTE-A, CDMA, GSM, and other wireless technologies.

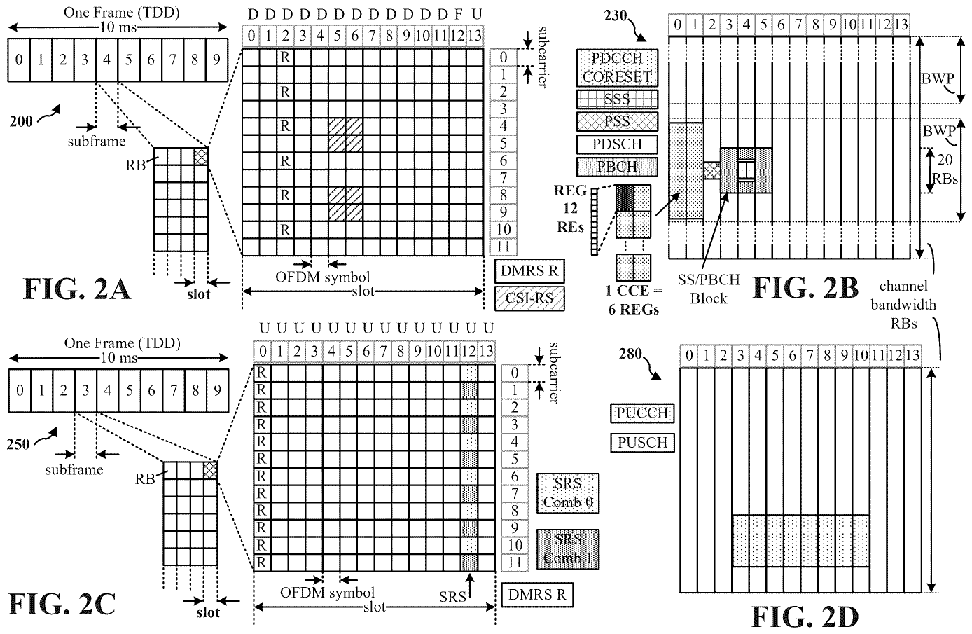

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Similar aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

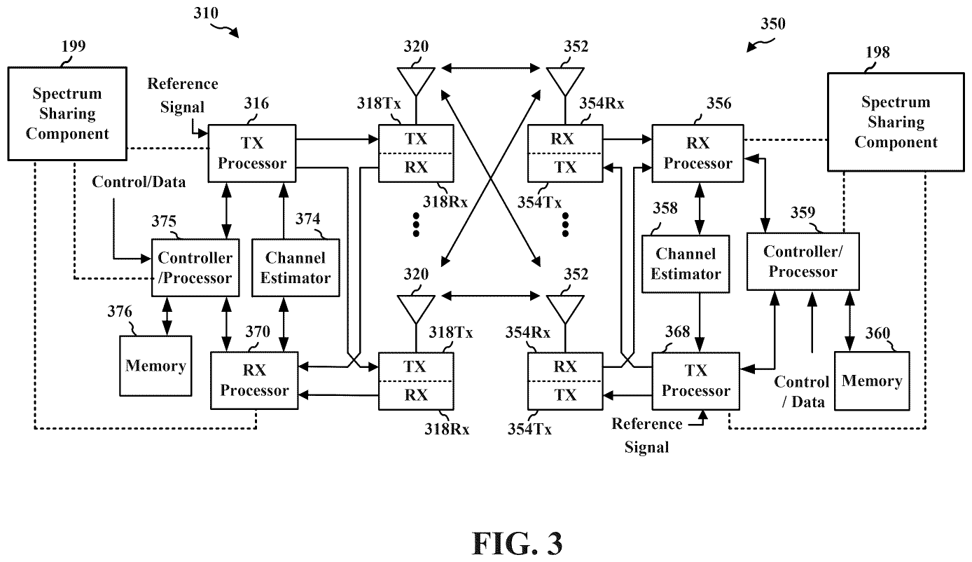

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the spectrum sharing component 198 of FIG. 1.

At least one of the TX processor 316, the RX processor 370, and the controller/processor 375 may be configured to perform aspects in connection with the spectrum sharing component 199 of FIG. 1.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time may enable more efficient use of the wireless spectrum. Full duplex operation may include simultaneous transmission and reception in the same frequency range. In some examples, the frequency range may be a millimeter wave (mmW) frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

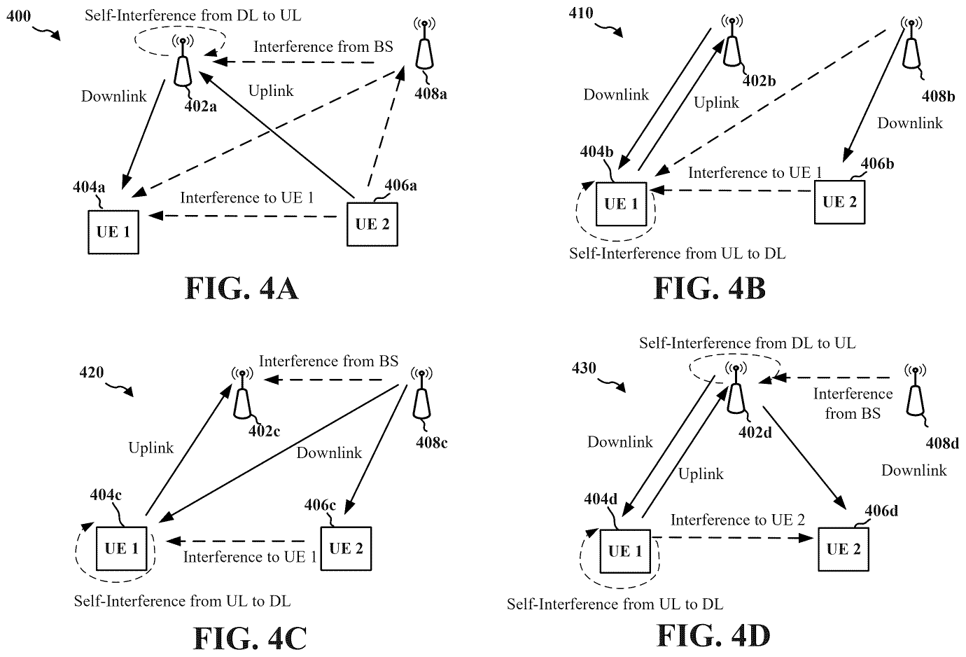

FIG. 4A, FIG. 4B, FIG. 4C, and FIG. 4D illustrate various modes of full duplex communication. Full duplex communication supports transmission and reception of information over the same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows a second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows a fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404b when receiving downlink communication from the base station 402d.

There may be various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication

In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode.

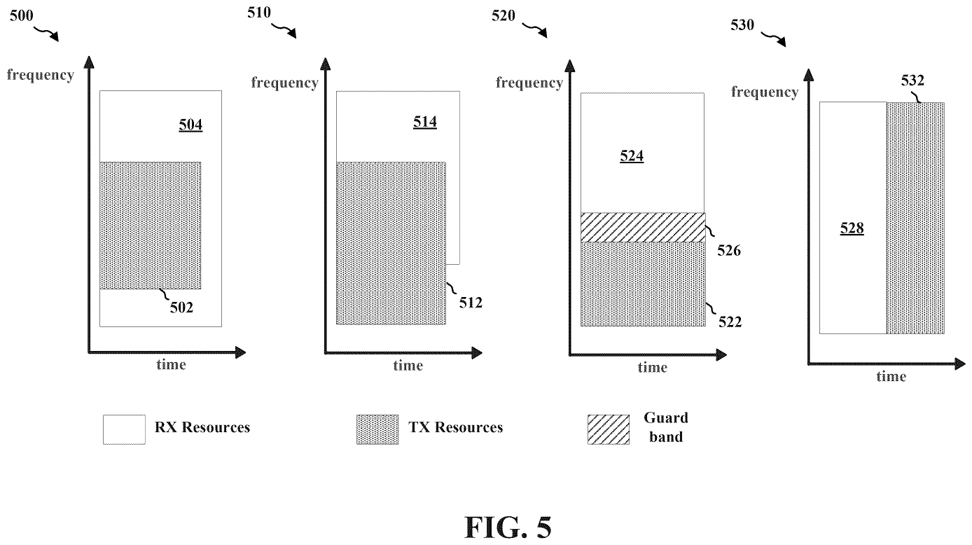

Full duplex communication may be in the same frequency band. The uplink and downlink communication may be in different frequency subbands, in the same frequency subband, or in partially overlapping frequency subbands. FIG. 5 illustrates a first example 500 and a second example 510 of in-band full-duplex (IBFD) resources and a third example 520 of SBFD resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to subband FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Subband FDD may also be referred to as “flexible duplex.”

A fourth example 530 illustrates an example of half-duplex resources in which the reception resources 528 do not overlap in time with the transmission resources 532.

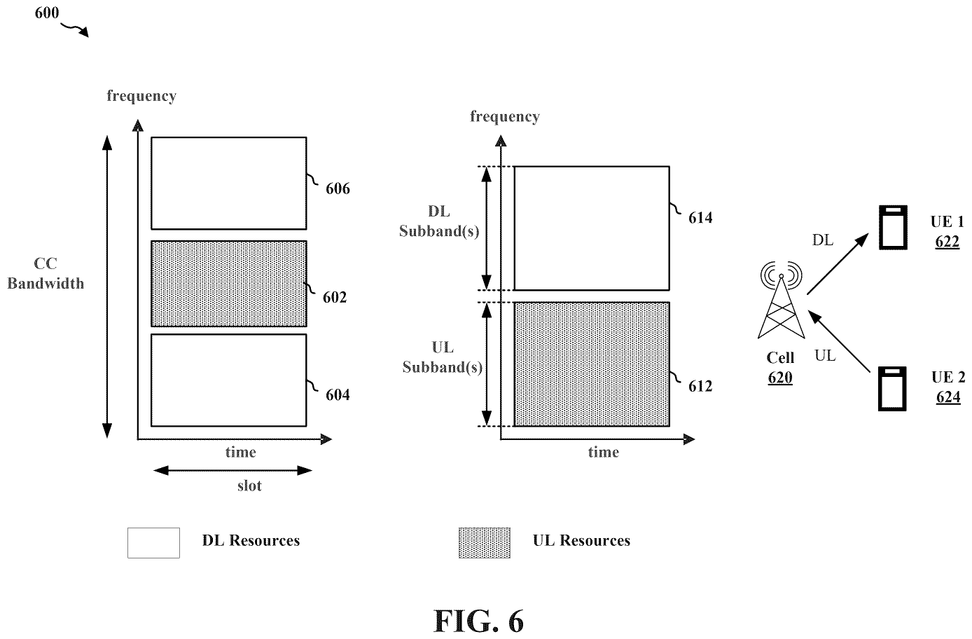

FIG. 6 is a diagram 600 illustrating an example of SBFD operation. As shown in FIG. 6, a cell 620 may have DL communication with one UE (e.g., UE 1 622), and simultaneously have UL communication with another UE (e.g., UE 2 624) on the same slot. In one example, the DL communication with UE 1 622 may utilize DL resources 604, 606, and the UL communication with UE 2 624 may utilize UL resources 602. In another example, the DL communication with UE 1 622 may utilize DL resources 614, and the UL communication with UE 2 624 may utilize UL resources 612.

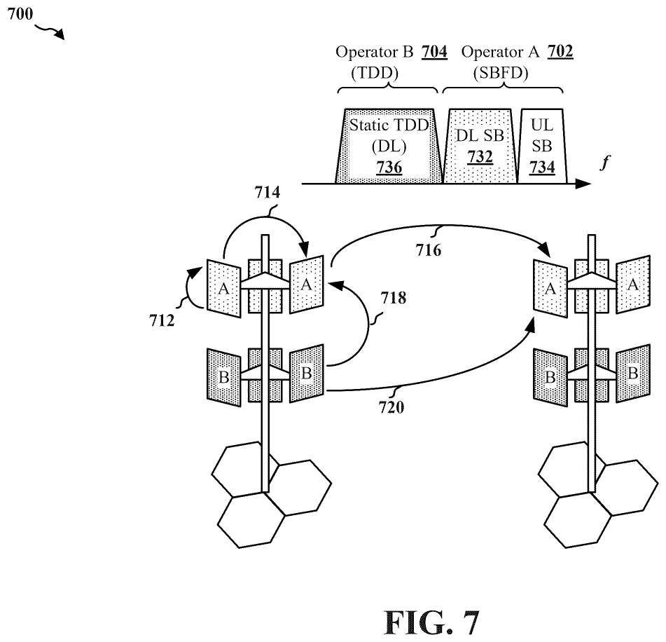

In wireless communication, one of the main limitations for the widespread adoption of SBFD operation is the inter-operator CLI. FIG. 7 is a diagram 700 illustrating various interferences in wireless communication involving multiple operators. The example in FIG. 7 may involve two operators (e.g., operator A 702 and operator B 704). Operator A 702 may operate in an SBFD mode in a downlink subband 732 and an uplink subband 734. Operator B 704 may operate in a time division duplexing (TDD) mode in a TDD band 736. As used herein, an “operator” may refer to an entity or organization that provides and manages wireless communication for users. For example, each operator may have an associated core network (e.g., core network 120).

As shown in FIG. 7, the interferences during the operations of operator A 702 and operator B 704 may include self-interference 712, which may occur due to simultaneous transmission and reception, intra-operator interference between base stations of the same operator (e.g., co-channel inter-gNB CLI 714 and 716), and inter-operator interference caused by the communication of different operators (e.g., adjacent-channel inter-gNB CLI 718, 720).

Since there is typically no direct link or exchange of information between different operators (e.g., no Xn or F1AP interfaces between operator A 702 and operator B 704), mitigating inter-operator CLI (e.g., adjacent-channel inter-gNB CLI 718, 720) often relies on techniques such as spatial isolation and/or physical separation. This makes the issue particularly challenging to address in scenarios where operators are collocated at the same site (e.g., adjacent-channel inter-gNB CLI 718).

On the other hand, for the CLI between the base stations (e.g., inter-gNB CLI) involving the same operator (e.g., co-channel inter-gNB CLI 714, 716), both CLI across sectors of the same site (e.g., co-channel inter-gNB CLI 714) and CLI between sectors of different sites (e.g., co-channel inter-gNB CLI 716) may be mitigated using certain techniques. For example, CLI between sectors of the same site (e.g., co-channel inter-gNB CLI 714) may be managed by employing baseband interference cancellation. CLI and channel measurements across the base stations of different sites may facilitate transmitter/receiver (Tx/Rx) beam-nulling in frequency range 1 (FR1) and beam pairing. In some examples, duplex enhancements may be used to mitigate inter-gNB CLI for the same operator (e.g., co-channel inter-gNB CLI 714).

In some examples, a radio access network (RAN) may be shared by multiple operators. RAN sharing involves the deployment of a shared RAN while maintaining separate core networks for each operator. RAN sharing allows different operators to differentiate their services for competition, while using shared RAN infrastructure. The shared deployment can include the full RAN or some components of RAN, such as the RU alone.

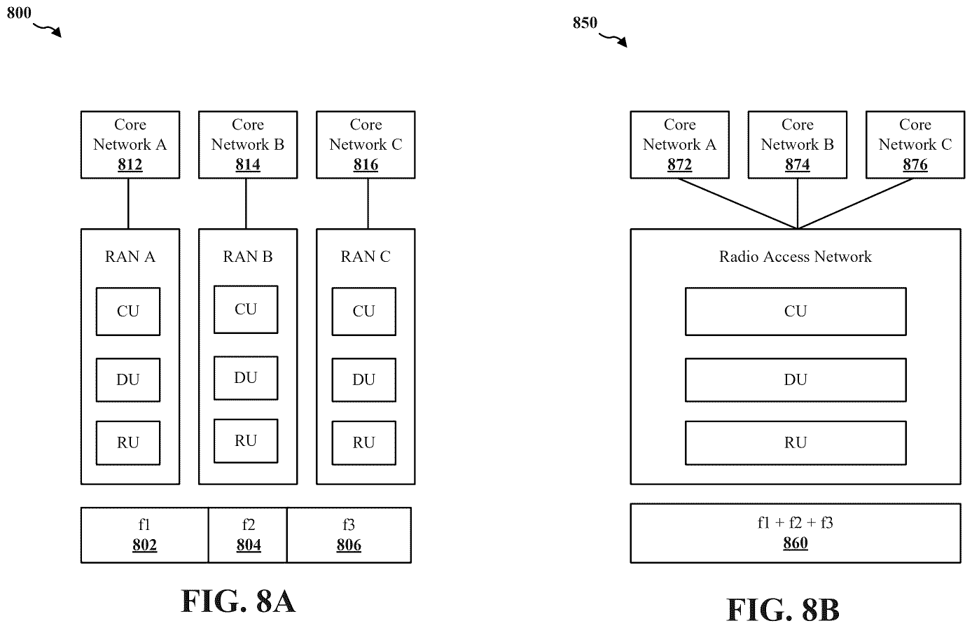

The RAN sharing may be implemented in different ways. In one configuration, RAN sharing may involving allocating a fixed narrow carrier, which may have a bandwidth of, for example, an integer multiple of 100 MHz (e.g., Nx100 MHz, where N is an integer) for each operator. FIG. 8A is a diagram 800 illustrating an example of RAN sharing among multiple operators. As shown in FIG. 8A, fixed narrow carriers, such as f1 802, f2 804, and f3 806, may be respectively allocated for the operators sharing the RAN, such as operator A (e.g. core network A812), operator B (e.g., core network B 814), and operator C (e.g., core network C 816). As an example, the fixed narrow carrier allocated to operator A 812 (e.g., f1 802) may have a bandwidth of 200 MHz, the fixed narrow carrier allocated to operator B 814 (e.g., f2 804) may have a bandwidth of 100 MHz, and the fixed narrow carrier allocated to operator C 816 (e.g., f3 806) may have a bandwidth of 200 MHz. The bandwidth allocation for each operator may be based on their individual spectrum holdings.

In another configuration, a dynamic wide carrier, such as a 500 MHz bandwidth, may be used for RAN sharing among multiple operators. FIG. 8B is a diagram 850 illustrating an example of RAN sharing among multiple operators. As shown in FIG. 8B, the dynamic wide carrier 860 (e.g., a 500 MHz bandwidth) may be managed through a single carrier and scheduler for multiple operators (e.g., core network A 872, core network B 874, core network C 876) sharing the RAN, with quality of service (QoS) enforced based on operator agreements. In some examples, using a wide carrier 860 (e.g., a 500 MHz bandwidth) via a single carrier and scheduler may achieve higher trunking efficiency and better coexistence with other services (e.g., non-international mobile telecommunications (non-IMT) services) on subbands. Additionally, a wide carrier (e.g., wide carrier 860) may enable the deployment of new wideband services, such as high-resolution sensing. Hence, RAN sharing with a large channel bandwidth (e.g., wide carrier 860) allows for reduced cost deployment and provides a better user experience with dynamic spectrum sharing.

In some aspects, the RAN sharing among multiple operators may enable new duplexing schemes, which may not be feasible in isolated deployments. In some examples, with RAN/spectrum sharing among multiple operators, the CLI between operators at the same site (e.g., adjacent-channel inter-gNB CLI 718) may be managed through digital interference cancellation. For example, the solutions used for handling CLI between sites of the same operator, such as transmitter/receiver (Tx/Rx) nulling and beam pairing, may be applied to manage cross-site CLI between different operators (e.g., adjacent-channel inter-gNB CLI 720).

In some aspects, SBFD may be enabled in a wide component carrier (CC) with RAN shared among multiple operators to improve spectrum efficiency and support interference mitigation for the CLI across the multiple operators. In some aspects, the downlink (DL) subband and uplink (UL) subband within a large component carrier, such as one with a 400 MHz bandwidth, may be divided into multiple smaller DL/UL paired subbands (or channels), each paired DL/UL subbands (or channels) allocated to a respective operator. These smaller downlink or uplink subbands allocated to individual operators may be referred to as operator subbands, in contrast to the downlink or uplink subbands (e.g., downlink carrier subband or uplink carrier subband) in a wide component carrier, which may be shared among multiple operators.

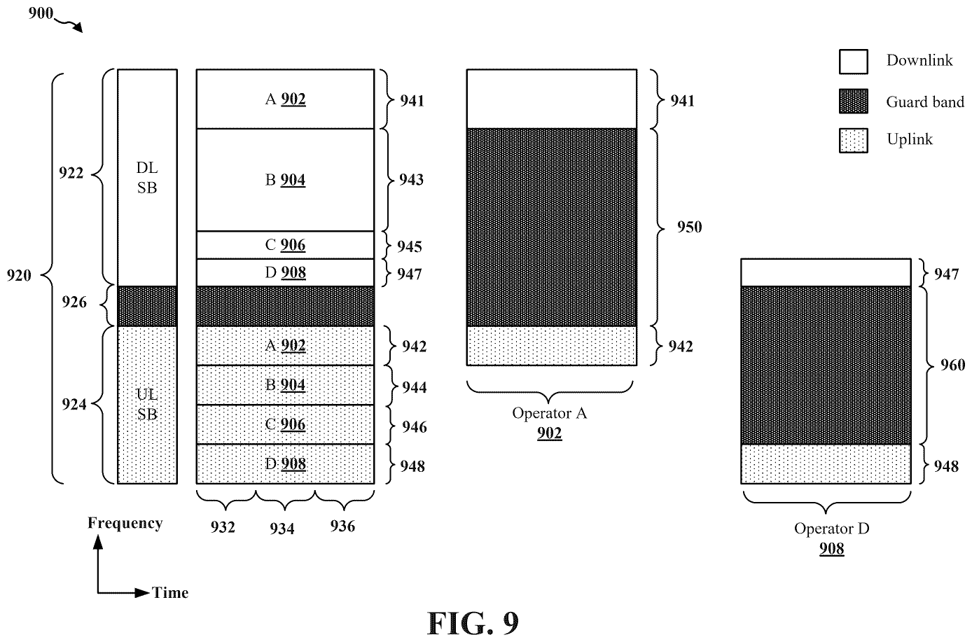

FIG. 9 is a diagram 900 illustrating an example of a wide component carrier being shared among multiple operators in accordance with various aspects of the present disclosure. As shown in FIG. 9, four operators, including operator A 902, operator B 904, operator C 906, and operator D 908, may share a wide component carrier (e.g., component carrier 920). For example, the component carrier 920 may include a downlink subband 922 and an uplink subband 924. In some examples, the downlink subband 922 and the uplink subband 924 may be separated by a guard band 926. In some examples, the downlink subband 922 in the component carrier 920 may be referred to as the downlink carrier subband, and the uplink subband 924 in the component carrier 920 may be referred to as the uplink carrier subband. The wide component carrier may be divided into multiple paired downlink and uplink operator subbands, with each paired downlink and uplink operator subbands allocated to one operator. For example, as shown in FIG. 9, component carrier 920 may be divided into paired downlink and uplink operator subbands, including paired downlink operator subband 941 and uplink operator subband 942 for operator A 902, paired downlink operator subband 943 and uplink operator subband 944 for operator B 904, paired downlink operator subband 945 and uplink operator subband 946 for operator C 906, and paired downlink operator subband 947 and uplink operator subband 947 for operator D 908.

In some examples, all symbols associated with these operator subbands may be SBFD symbols, enabling simultaneous transmission and reception. For example, in FIG. 9, the component carrier 920 may occupy three symbols 932, 934, 936, and all of these symbols may be SBFD symbols.

In some aspects, each operator may be assigned a paired DL/UL operator subbands (or channels). These DL and UL operator subbands (or channels) may be either uniform or non-uniform in size in the frequency domain, meaning they may have the same or different bandwidths. For example, the downlink operator subband 945 for operator C 906 and the downlink operator subband 947 for operator D 908 may have the same size (or bandwidth) in the frequency domain, while the downlink operator subband 943 for operator B 904 may have a different size (or bandwidth) from the downlink operator subband 945 for operator C 906.

In some examples, the allocation of these operator subbands (or channels) for each operator may be done in a semi-static manner (e.g., via a semi-static configuration) with fixed pairing. In some examples, the allocation of these operator subbands (or channels) for each operator may be implemented dynamically (e.g., via a dynamic configuration), allowing more flexible use of frequency resources.

From the UE's perspective, each operator (e.g., operator A 902, operator B 904, operator C 906, operator D 908) may be SBFD capable within the wide CC bandwidth. For example, referring to FIG. 9, operator A 902 may be SBFD capable with the downlink operator subband 941 and uplink operator subband 942, with the bandwidth between these two operator subbands serving as a guard band 950. Similarly, operator D 908 may be SBFD capable with the downlink operator subband 947 and uplink operator subband 948, with the bandwidth between these two operator subbands serving as a guard band 960.

In some examples, the UL and DL operator subbands for an operator in a large CC may remain fixed. In some examples, the UL and DL operator subbands for an operator in a large CC may be obtained by splitting the UL and DL subbands for each operator via a semi-static configuration. In some examples, the UL and DL operator subbands for an operator in a large CC may be changed dynamically (e.g., via a dynamic configuration), enabling dynamic SBFD operation that adapts the division of frequency resources in real time.

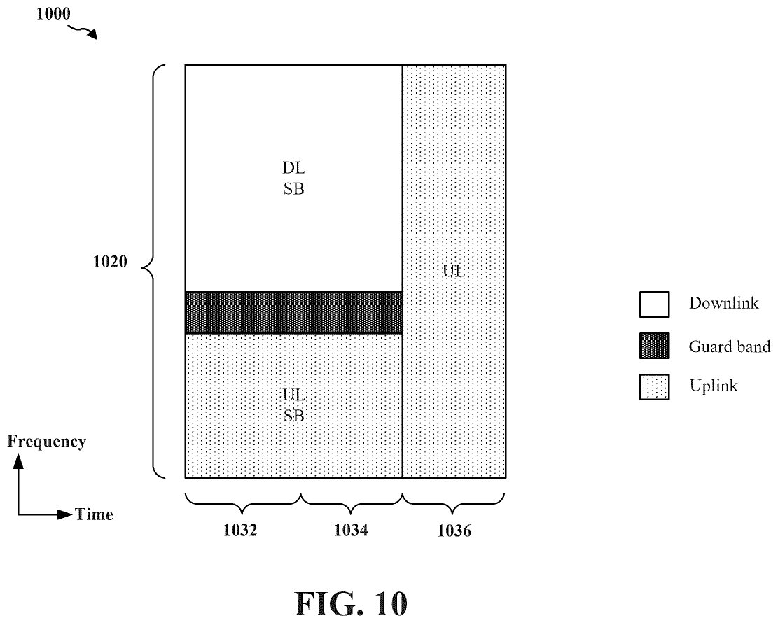

In some aspects, one or more symbols associated with the wide CC (e.g., component carrier 920) may be reserved for downlink/uplink reciprocity, such as sounding reference signals (SRS), while the other symbols may be SBFD symbols. FIG. 10 is a diagram 1000 illustrating an example of a wide component carrier including an uplink symbol and SBFD symbols in accordance with various aspects of the present disclosure. As shown in FIG. 10, the wide component carrier 1020 may occupy three symbols 1032, 1034, 1036. Two of these symbols (e.g., symbols 1032, 1034) may be SBFD symbols, while the third symbol 1036 may be an uplink symbol, which may be a symbol reserved for downlink/uplink reciprocity.

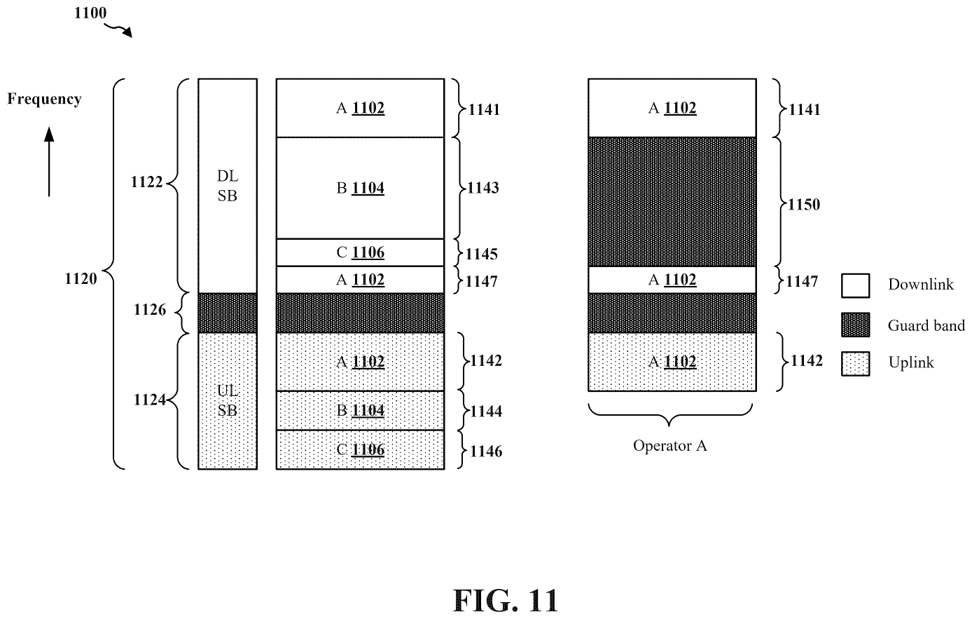

In some aspects, each operator may be assigned one or more DL operator subbands and one UL operator subband. FIG. 11 is a diagram 1100 illustrating an example of a wide component carrier being shared among multiple operators in accordance with various aspects of the present disclosure. As shown in FIG. 11, three operators, including operator A 1102, operator B 1104, and operator C 1106, may share a wide component carrier 1120. For example, the component carrier 1120 may include a downlink subband 1122 and an uplink subband 1124. In some examples, the downlink subband 1122 and the uplink subband 1124 may be separated by a guard band 1126. In some examples, the downlink subband 1122 in the wide component carrier 1120 may be referred to as the downlink carrier subband, and the uplink subband 1124 in the wide component carrier 1120 may be referred to as the uplink carrier subband.

As shown in FIG. 11, operator A 1102 may be assigned two downlink operator subbands (e.g., downlink operator subbands 1141 and 1147) and one uplink operator subband 1142. On the other hand, operator B 1104 may be assigned one downlink operator subband 1143 and one uplink operator subband 1144, and operator C 1106 may be assigned one downlink operator subband 1145 and one uplink operator subband 1146.

The DL operator subbands assigned to an operator may be contiguous or non-contiguous within the overall carrier bandwidth. This structure allows flexible resource allocation while maintaining the ability to perform SBFD operations efficiently across multiple operators sharing the same wideband spectrum. For example, in the example of FIG. 11, the two downlink operator subbands (e.g., downlink operator subbands 1141 and 1147) are non-contiguous within the carrier bandwidth, and the bandwidth between the two downlink operator subbands (e.g., downlink operator subbands 1141 and 1147) may server as a guard band 1150.

In some examples, the downlink subband (e.g., downlink carrier subband 922) and the uplink subband (e.g., uplink carrier subband 924) in a wide component carrier (e.g., component carrier 920) may be dynamically split into multiple downlink operator subbands or uplink operator subbands for multiple operators. In this case, the sizes of uplink and downlink operator subbands may be dynamically adjusted based on current network needs. The updated subband sizes may be signaled either through system information block 1 (SIB1) or via a group common-downlink control information (GC-DCI) message, which may indicate the new operator subband sizes and their corresponding locations within the component carrier.

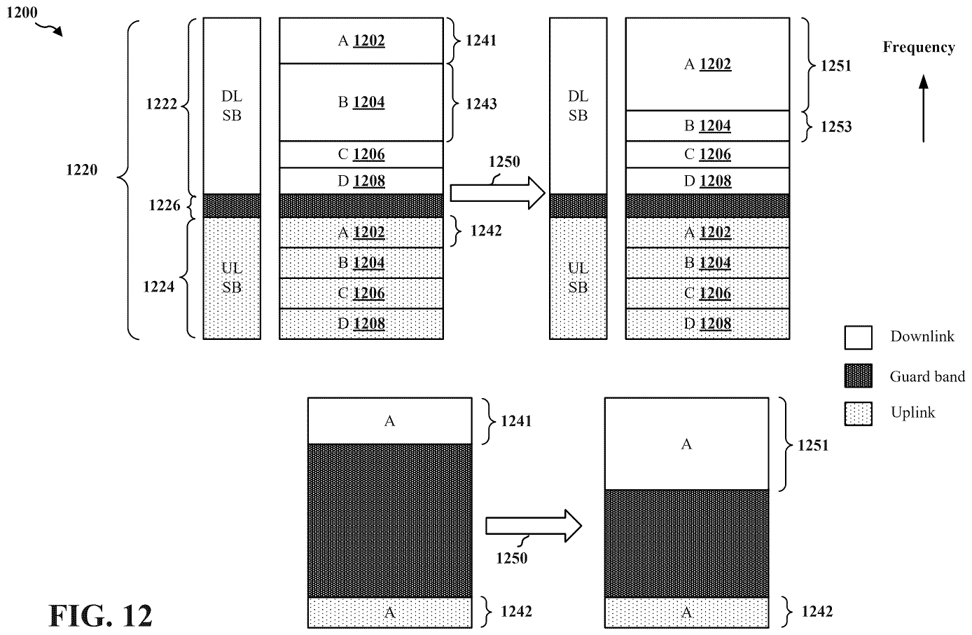

FIG. 12 is a diagram 1200 illustrating an example of dynamic subband splitting in a wide component carrier in accordance with various aspects of the present disclosure. As shown in FIG. 12, four operators, including operator A 1202, operator B 1204, operator C 1206, and operator D 1208, may share a wide component carrier 1220. For example, the component carrier 1220 may include a downlink carrier subband 1222 and an uplink carrier subband 1224. In some examples, the downlink carrier subband 1222 and the uplink carrier subband 1224 may be separated by a guard band 1226. As shown in FIG. 12, operator A 1202 may be assigned a downlink operator subband 1241, and operator B 1204 may be assigned a downlink operator subband 1243. In some examples, the downlink carrier subband 1222 may be dynamically split (e.g., at 1250), resulting in a change to the size and/or location of the downlink operator subbands. For example, in FIG. 12, the dynamic splitting (e.g., at 1250) may increase the size of the downlink operator subband (e.g., at 1251) for operator A 1202, and decrease the size of downlink operator subband (e.g., at 1253) for operator B 1204. From the perspective of operator A 1202, its downlink operator subband may be dynamically increased from the size of downlink operator subband 1241 to the size of downlink operator subband 1251. On the other hand, the size of the uplink operator subband 1242 may remain unchanged.

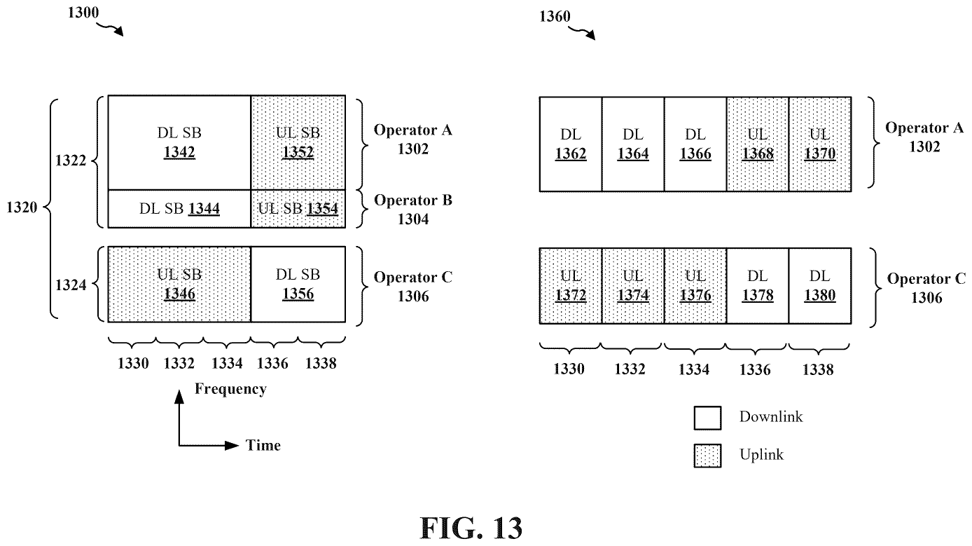

In some aspects, multiple operators may share a wide component carrier (e.g., a 400 MHz bandwidth) via dynamic TDD across the multiple operators. FIG. 13 shows diagrams illustrating an example of sharing a wide component carrier among multiple operators using dynamic TDD in accordance with various aspects of the present disclosure. As shown in FIG. 13, in diagram 1300, a wide component carrier 1320 may be shared among three operators, including operator A 1302, operator B 1304, and operator C 1306. For example, the component carrier 1320 may include a first subband 1322 and a second subband 1324.

In some examples, the first subband 1322 and the second subband 1324 in the wide CC (e.g., component carrier 1320) may be divided into multiple downlink operator subbands or uplink operator subbands. For example, the component carrier 1320 may occupy five symbols (e.g., symbols 1330, 1332, 1334, 1336, 1338). In symbols 1330, 1332, 1334, the first subband 1322 may be divided into downlink operator subband 1342 (for operator A 1302) and downlink operator subband 1344 (for operator B 1304), and the second subband 1324 may retain as a single uplink operator subband 1346 (for operator C 1306). In symbols 1336 and 1338, the first subband 1322 may be divided into uplink operator subband 1352 (for operator A 1302) and downlink operator subband 1354 (for operator B 1304), and the second subband 1324 may retain as a single downlink operator subband 1356 (for operator C 1306).

In the example in FIG. 13, each operator (e.g., operator A 1302, operator B 1304, and operator C 1306) may be assigned one operator subband (e.g., either a downlink operator subband or an uplink operator subband) for a set of time resources. For example, at symbol 1330, operator A 1302 is assigned one downlink operator subband 1362 but is not assigned any uplink operator subband, and operator C 1306 is assigned one uplink operator subband 1372 but is not assigned any downlink operator subband.

In some examples, the symbols associated with the wide CC (e.g., symbols 1330, 1332, 1334, 1336, 1338) may be SBFD symbols, but the downlink and uplink subbands may not be the same across different SBFD symbols, allowing for flexible duplexing patterns. For example, in symbols 1330, 1332, 1334, the first subband 1322 is a downlink subband, and the second subband 1324 is an uplink subband. In symbols 1336, 1338, the first subband 1322 is an uplink subband, and the second subband 1324 is a downlink subband. That is, the component carrier 1320 may have a DL-to-UL (DU) split (e.g., at symbols 1330, 1332, 1334) followed by a UL-to-DL (UD) split (e.g., at symbols 1336, 1338).

In some examples, each operator may be assigned one operator subband, either for downlink or uplink, using frequency division multiplexed (FDMed) spectrum sharing. Diagram 1360 in FIG. 13 shows the allocation of operator subbands to different operators based on the sharing of wide CC (e.g., component carrier 1320) in diagram 1300. As shown in diagram 1360, in each of symbols 1330, 1332, 1334, operator A 1302 is assigned one downlink operator subband (e.g., 1362, 1364, or 1366), operator C 1306 is assigned one uplink operator subband (e.g., 1372, 1374, or 1376). In each of symbols 1336, 1338, operator A 1302 is assigned one uplink operator subband (e.g., 1368 or 1370), and operator C 1306 is assigned one downlink operator subband (e.g., 1378 or 1380).

In some examples, the allocation of these operator subbands may be semi-static (e.g., via a semi-static configuration), and each operator may be a semi-static (DL/UL) TDD operator. In some examples, the allocation of these operator subbands may be dynamic (e.g., via a dynamic configuration).

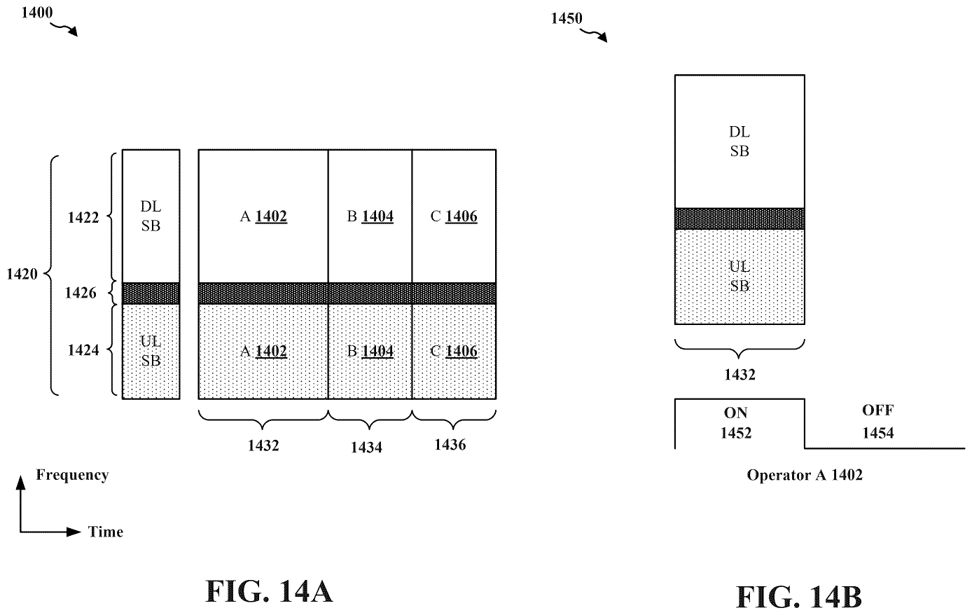

In some aspects, a time division multiplexing (TDM) based approach may be employed for RAN sharing among multiple operators in a wide component carrier (e.g., a 400 MHz bandwidth). FIG. 14A is a diagram 1400 illustrating an example of TDM based RAN sharing of a wide component carrier in accordance with various aspects of the present disclosure. As shown in FIG. 14A, a wide component carrier 1420 may be shared among three operators, including operator A 1402, operator B 1404, and operator C 1406. For example, the component carrier 1420 may include a downlink carrier subband 1422 and an uplink carrier subband 1424. In some examples, the downlink carrier subband 1422 and the uplink carrier subband 1424 may be separated by a guard band 1426.

In FIG. 14A, the entire spectrum of a large component carrier (e.g., component carrier 1420) may be shared across different operators by assigning specific time slots to each operator. For example, the entire spectrum (e.g., downlink carrier subband 1422 and uplink carrier subband 1424) of component carrier 1420 may be assigned to operator A 1402 during time slot (e.g., symbol or slot) 1432, assigned to operator B 1404 during time slot (e.g., symbol or slot) 1434, and assigned to operator C 1406 during time slot (e.g., symbol or slot) 1436. In some examples, the time sharing between operators may be configured as either semi-static or dynamic.

In some aspects, the sharing of the time slots within the wide CC may be signaled to the UE as cell ON/OFF cycles, such as discontinuous transmission (DTX) and discontinuous reception (DRX) cycles. In some examples, these cell ON/OFF cycles may be configured based on semi-static sharing. In some examples, these cell ON/OFF cycles may be configured based on dynamic sharing, such as that provided by the group common downlink control information (GC-DCI). FIG. 14B is a diagram 1450 illustrating an example of a cell ON/OFF cycle based on the sharing of a wide component carrier among multiple operators in accordance with various aspects of the present disclosure. As shown in FIG. 14B, the cell ON/OFF cycles for operator A 1402 may include one or more ON durations (e.g., ON duration 1452) and one or more OFF durations (e.g., OFF duration 1454). The one or more ON durations (e.g., ON duration 1452) may correspond to time slots during which operator A 1402 is assigned the spectrum in the component carrier, such as time slot 1432, and the one or more OFF durations (e.g., OFF duration 1454) may correspond to time slots during which operator A 1402 is not assigned the spectrum in the component carrier, such as time slots 1434, 1436.

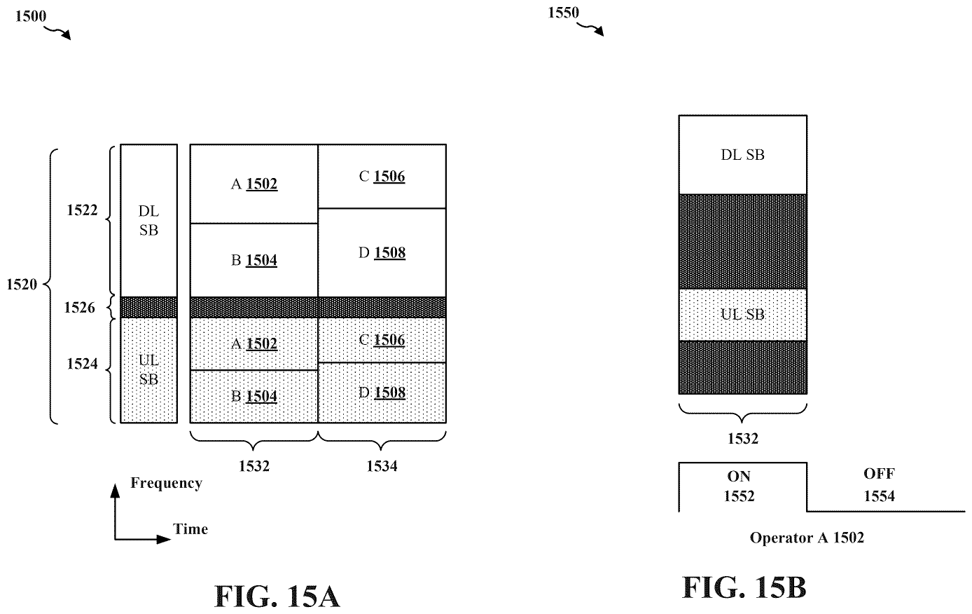

In some aspects, a combined time division multiplexing (TDM) and frequency division multiplexing (FDM) approach may be used for RAN sharing among multiple operators in a wide component carrier (e.g., a 400 MHz bandwidth). FIG. 15A is a diagram 1500 illustrating an example of RAN sharing of a wide component carrier based on a combined TDM and FDM in accordance with various aspects of the present disclosure. As shown in FIG. 15A, a wide component carrier 1520 may be shared among four operators, including operator A 1502, operator B 1504, operator C 1506, and operator D 1508. For example, the component carrier 1520 may include a downlink carrier subband 1522 and an uplink carrier subband 1524. In some examples, the downlink carrier subband 1522 and the uplink carrier subband 1524 may be separated by a guard band 1526.

As shown in FIG. 15A, the entire spectrum of a wide component carrier 1520 may be shared across different groups of operators by distributing it in both the time and frequency domains. Each group of operators may share the spectrum in an FDM manner during designated sets of time slots. For example, a first group of operators may include operator A 1502 and operator B 1504, which may share downlink carrier subband 1522 and uplink carrier subband 1524 via FDM during time slot 1532. The second group of operators may include operator C 1506 and operator D 1508, which may share downlink carrier subband 1522 and uplink carrier subband 1524 via FDM during time slot 1534.

In some examples, the splits of the uplink and downlink subband (e.g., downlink carrier subband 1522 and uplink carrier subband 1524) for a group of operators may be the same across the various sets of time slots. In some examples, the splits of the uplink and downlink subband (e.g., downlink carrier subband 1522 and uplink carrier subband 1524) for a group of operators may be different across the various sets of time slots. For example, in FIG. 15A, the splits of downlink carrier subband 1522 and uplink carrier subband 1524 for the first group of operators (including operator A 1502 and operator B 1504) at time slot 1532 is different from the splits of downlink carrier subband 1522 and uplink carrier subband 1524 for the second group of operators (including operator C 1506 and operator D 1508) at time slot 1534.

In some examples, the time-based sharing (e.g., in the time domain) and the operator subband sharing (e.g., in the frequency domain) may be semi-static (e.g., via a semi-static configuration) or dynamic (e.g., via a dynamic configuration).

In some aspects, the time-based sharing (e.g., in the time domain) and the operator subband sharing (e.g., in the frequency domain) may be signaled to the UE as cell ON/OFF cycles, such as discontinuous transmission (DTX) and discontinuous reception (DRX) cycles. In some examples, these cell ON/OFF cycles may be configured based on semi-static sharing. In some examples, these cell ON/OFF cycles may be configured based on time-based sharing of the component carrier. FIG. 15B is a diagram 1550 illustrating an example of a cell ON/OFF cycle based on the time-based sharing of a wide component carrier among multiple operators in accordance with various aspects of the present disclosure. As shown in FIG. 15B, the cell ON/OFF cycles for operator A 1502 may include one or more ON durations (e.g., ON duration 1552) and one or more OFF durations (e.g., OFF duration 1554). The one or more ON durations (e.g., ON duration 1552) may correspond to time slots during which operator A 1502 is assigned the spectrum in the component carrier, such as time slot 1532, and the one or more OFF durations (e.g., OFF duration 1554) may correspond to time slots during which operator A 1502 is not assigned the spectrum in the component carrier, such as time slots 1534.

In some aspects, to support the RAN sharing and SBFD operation among multiple operators in a wide CC, the network and the UE may exchange related information via various signaling mechanisms. In some examples, system information blocks (SIBs) may be used to provide the identities (IDs) of operators sharing the spectrum, such as operator A 902, operator B 904, operator C 906, operator D 908 in the example in FIG. 9. In some examples, the SIBs may further include information about the associated RAN sharing mechanisms (or RAN sharing mode). For example, the spectrum sharing among multiple operators may be one of three spectrum sharing modes. The first spectrum sharing model is the FDD/paired mode. In the FDD/paired mode, each operator (e.g., operator A 902) is allocated a downlink operator subband (or channel), such as downlink operator subband 941, and an uplink operator subband (or channel), such as uplink operator subband 942, within the component carrier (e.g., component carrier 920). The second spectrum sharing mode is TDD mode. In the TDD mode, each operator (e.g., operator A 1302) may be allocated a single operator subband (e.g., downlink operator subband 1362 in symbol 1330) for TDD operation, along with an associated TDD pattern. The third spectrum sharing mode is SBFD mode, which may be a combination of the first mode (e.g., the FDD/paired mode) and the second mode (e.g., the TDD mode). In the SBFD mode, two operator subbands associated with the same operator may have the same direction (e.g., either DL or UL) during certain time resources. For each of these three spectrum sharing modes, SIB type 1 (SIB1) may be used to indicate whether the sharing is configured as fixed or dynamic.

In some examples, the SIB may further include information regarding the RAN and spectrum sharing configuration. If a fixed spectrum sharing has been used, the frequency locations of the paired DL/UL operator subband or TDD unpaired operator subbands may be indicated with reference to a single set of common resource blocks (RBs). If a dynamic spectrum sharing has been used, multiple sets of paired DL/UL operator subbands or unpaired subbands (e.g., TDD subbands) may be broadcasted. Each set may include the frequency locations of the respective paired DL/UL operator subbands or unpaired TDD subbands. In some examples, switching between these sets of paired DL/UL operator subbands or unpaired subbands (e.g., TDD subbands) may be signaled through SIB1 updates, GC-DCI messages that indicate new subband sizes and locations, or via paging procedures.

In some examples, the SIB may further include information related to the associated time-sharing cycle. For example, for each operator of the multiple operators, SIB1 may carry the ON/OFF duty cycle information, defining the time resources during which each operator is active or inactive. For example, referring to FIG. 15B, the ON/OFF duty cycle information for operator A 1502 may indicate that operator A 1502 is active during time slot 1532 (e.g., during ON duration 1552) and inactive during time slot 1534 (e.g., during OFF duration 1554).

In some aspects, to support the RAN sharing and SBFD operation among multiple operators in a wide CC, several signaling mechanisms may be provided to exchange related information. For example, the RAN and spectrum sharing information messages may be broadcasted from one single SIB (or multiple SIBs) for the entire shared carrier (or spectrum). These information messages can be transmitted through a single system information block (SIB) or distributed across multiple SIBs for the entire shared carrier or spectrum.

In some examples, all relevant information may be included in SIB1. In some examples, SIB1 may carry the IDs of the operators and indicate the RAN sharing mode, while a separate SIB message, such as a special SIB cell-common message (SIBx), may carry the detailed information related to spectrum sharing across operators. In some examples, a single bit in SIB1 may be used to indicate whether the spectrum is shared or not. In this case, all remaining information, including operator IDs, spectrum sharing methods, and the ON/OFF duty cycle, may be included in a separate SIB message.

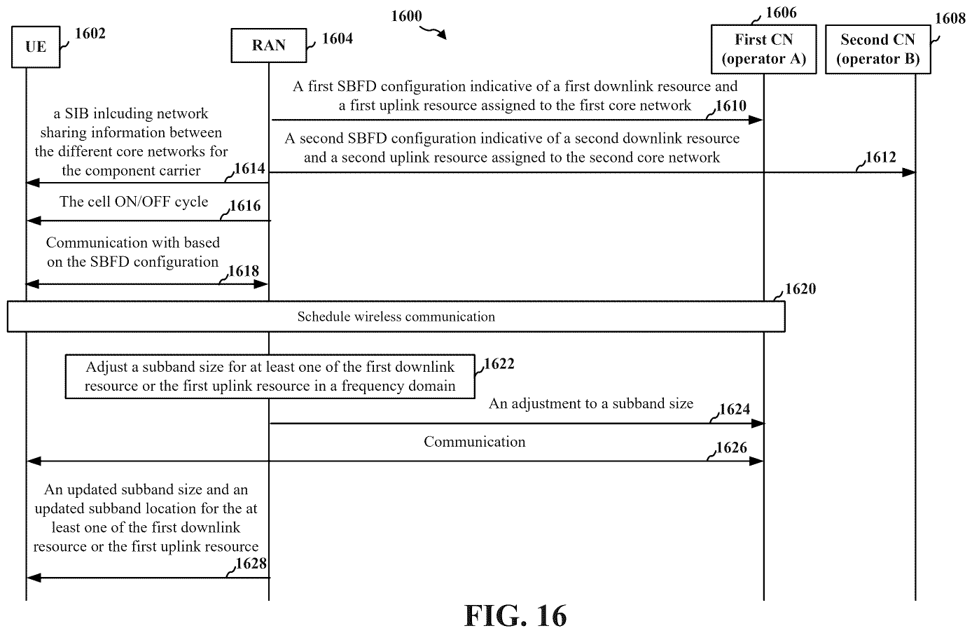

FIG. 16 is a call flow diagram 1600 illustrating a method of wireless communication in accordance with various aspects of this present disclosure. Various aspects are described in connection with a UE 1602, a RAN 1604, and a first core network 1606. The first core network 1606 may be core network 120 and may be associated with an operator (e.g., operator A 902). In some examples, the RAN 1604 may be shared among multiple core networks including the first core network 1606 and a second core network 1608. For example, the RAN 1604 may include or be associated with a base station and/or one or more components of a base station (e.g., a CU 110, a DU 130, and/or an RU 140). Various aspects in call flow diagram 1600 may be performed by the UE 1602 in collaboration with the RAN 1604 and the first core network 1606.

As shown in FIG. 16, at 1610, the RAN 1604 may provide to the first core network 1606 a first indication of a first downlink resource and a first uplink resource assigned to the first core network 1606 based on an SBFD configuration. For example, referring to FIG. 9, the first core network may be associated with operator A 902, a first downlink resource (e.g., downlink operator subband 941) and the first uplink resource (e.g., uplink operator subband 942) may be located in a component carrier 920, which may include multiple resources shared among different core networks (e.g., core network respectively associated with operator A 902, operator B 904, operator C 906, operator D 908) including a second core network (e.g., core network associated with operator B 904).

At 1612, the RAN 1604 may provide to the second core network 1608 a second indication of a second downlink resource and a second uplink resource assigned to the second core network based on the SBFD configuration. Referring to FIG. 9, the second downlink resource (e.g., downlink operator subband 943) and the second uplink resource (e.g., uplink operator subband 944) may be located in the component carrier 920 that include the multiple resources shared among the different core networks (e.g., core networks respectively associated with operator A 902, operator B 904, operator C 906, operator D 908) including the first core network (e.g., core network associated with operator A 902).

At 1614, the RAN 1604 may transmit, to UE 1602, a SIB including network sharing information between the different core networks (e.g., first core network 1606 and second core network 1608) for the component carrier (e.g., component carrier 920). For example, the network sharing information may include identifiers (IDs) of the different core networks (e.g., core network respectively associated with operator A 902, operator B 904, operator C 906, operator D 908) that sharing the component carrier (e.g., component carrier 920), spectrum sharing information among the different core networks (e.g., the FDD/paired mode in FIG. 9, TDD mode in FIG. 13, or SBFD mode), a spectrum sharing mode including a fixed spectrum sharing or a dynamic spectrum sharing, or time sharing information among the different core networks.

At 1616, the UE 1602 may receive cell ON/OFF cycle from the RAN 1604. Referring to FIG. 14B, the cell ON/OFF cycle may indicate one or more ON durations (e.g., ON duration 1452) during which a correspond core network (or operator) is active and one or more OFF durations (e.g., OFF duration 1454) during which the corresponding core network (or operator) in inactive.

At 1618, the RAN 1604 may communicate with UE 1602 based on the SBFD configuration. For example, referring to FIG. 11, if, based on the SBFD configuration, downlink operator subbands 1141, 1147, and uplink operator subband 1142 have been assigned to the first core network 1606 (associated with operator A), the first core network 1606 may use these operator subbands (e.g., downlink operator subbands 1141, 1147, and uplink operator subband 1142) to communicate with UE 1602.

At 1620, the first core network 1606 may schedule wireless communication for UE 1602 via the RAN 1604 based on the first downlink resource and the first uplink resource. For example, referring to FIG. 9, the first core network (associated with operator A 902) may schedule wireless communication for UE based on the first downlink resource (e.g., downlink operator subband 941) and the first uplink resource (e.g., uplink operator subband 942).

At 1622, the RAN 1604 may adjust the subband size for at least one of the first downlink resource or the first uplink resource in a frequency domain. For example, referring to FIG. 12, the RAN may increase the downlink operator subband for operator A 1202 from the size of the downlink operator subband 1241 to that of the downlink operator subband 1251. In some examples, the RAN may adjust the subband size dynamically.

At 1624, the RAN 1604 may transmit the adjustment to the subband size for at least one of the first downlink operator subband or the first uplink operator subband in the frequency domain to the first core network 1606.

At 1626, the UE 1602 may communicate with the first core network 1606 based on the downlink operator subband and the uplink operator subband. For example, referring to FIG. 9, the UE may communicate with the first core network (e.g., the core network associated with operator A 902) based on the downlink operator subband 941 and the uplink operator subband 942.

At 1628, the UE 1602 may receive from RAN 1604, via SIB1 or DCI, an updated subband size and an updated subband location for the at least one of the downlink operator subband (e.g., downlink operator subband 1241) or the uplink operator subband.

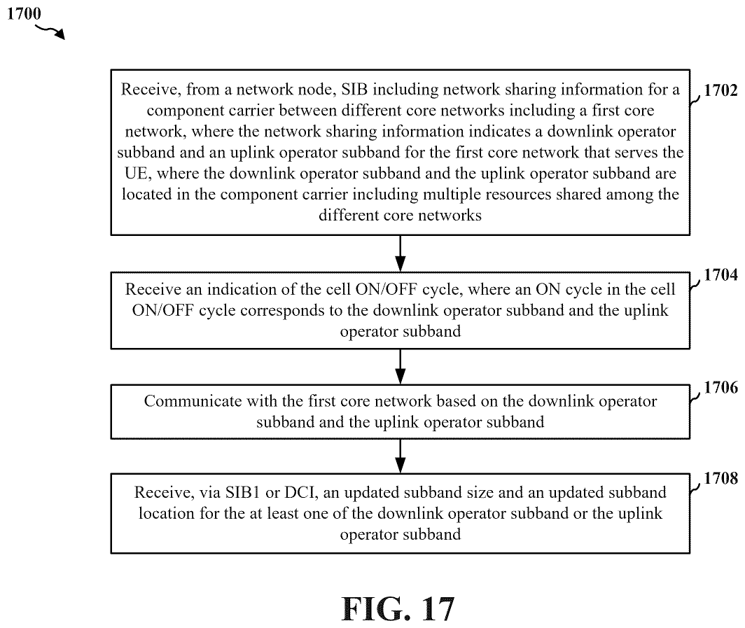

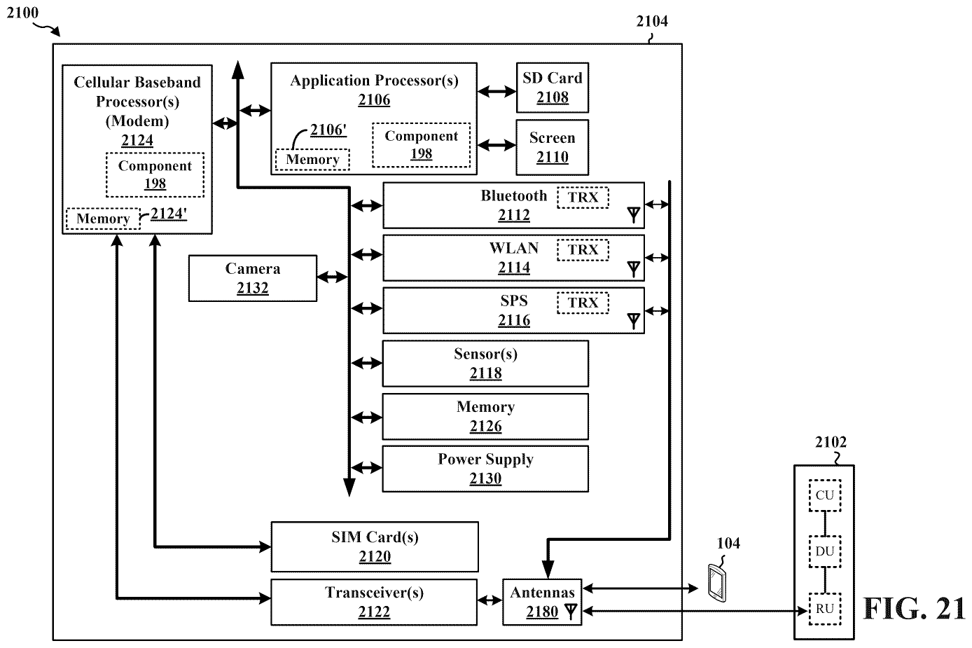

FIG. 17 is a flowchart 1700 illustrating methods of wireless communication at a UE in accordance with various aspects of the present disclosure. The method may be performed by a UE in collaboration with a network node and a core network. The network node may be a network entity, which may be a base station, or a component of a base station, in the access network of FIG. 1 or a core network component (e.g., base station 102, 310, RAN 1604; or the network entity 2102 in the hardware implementation of FIG. 21). The core network may be core network 120, or the first core network 1606. The UE may be the UE 104, 350, 1602, or the apparatus 2104 in the hardware implementation of FIG. 21. By implementing interference mitigation in shared RAN setups, the methods enable effective mitigation of CLI between operators, which is traditionally hard to manage due to a lack of inter-operator coordination. Additionally, by assigning paired downlink and uplink subbands to each operator within a large shared component carrier, the methods enable full SBFD capability for each operator independently and effective mitigation of CLI between operators. In some examples, by enabling TDM and FDM sharing of a component carrier for multiple operators, the methods improve spectrum flexibility and adaptability.

As shown in FIG. 17, at 1702, the UE may receive, from the network node, SIB including network sharing information for a component carrier between different core networks including a first core network, wherein the network sharing information indicates a downlink operator subband and an uplink operator subband for the first core network that serves the UE, wherein the downlink operator subband and the uplink operator subband are located in the component carrier including multiple resources shared among the different core networks. FIG. 9, FIG. 10, FIG. 11, FIG. 12, FIG. 13, FIG. 14A, FIG. 14B, FIG. 15A, FIG. 15B, and FIG. 16 illustrate various aspects of the steps in connection with flowchart 1700. For example, referring to FIG. 16, the UE 1602 may, at 1614, receive from the network node (e.g., RAN 1604) SIB including network sharing information for a component carrier between different core networks including a first core network 1606. Referring to FIG. 9, the network sharing information indicates a downlink operator subband (e.g., downlink operator subband 941) and an uplink operator subband (e.g., uplink operator subband 942) for the first core network 1606 that serves the UE 1602. The downlink operator subband (e.g., downlink operator subband 941) and the uplink operator subband (e.g., uplink operator subband 942) are located in the component carrier 920 including multiple resources shared among the different core networks. In some aspects, 1702 may be performed by the spectrum sharing component 198.

At 1706, the UE may communicate with the first core network based on the downlink operator subband and the uplink operator subband. For example, referring to FIG. 16, the UE 1602 may, at 1626, communicate with the first core network 1606 based on the downlink operator subband (e.g., downlink operator subband 941) and the uplink operator subband (e.g., uplink operator subband 942). In some aspects, 1706 may be performed by the spectrum sharing component 198.

At 1708, the UE may receive, via system information block type 1 (SIB1) or DCI, an updated subband size and an updated subband location for the at least one of the downlink operator subband or the uplink operator subband. For example, referring to FIG. 16, the UE 1602 may, at 1628, receive, via SIB1 or DCI, an updated subband size and an updated subband location for the at least one of the downlink operator subband or the uplink operator subband. In some aspects, 1708 may be performed by the spectrum sharing component 198.

In some aspects, the component carrier may be shared between the different core networks based on time division multiplexing (TDM) across multiple SBFD time resources and a distribution for the TDM is based on one or more of a cell ON/OFF cycle, a semi-static configuration, or a dynamic configuration. For example, referring to FIG. 14A, the component carrier 1420 may be shared between the different core networks based on TDM across multiple SBFD time resources (e.g., 1432, 1434, 1436) and a distribution for the TDM is based on one or more of a cell ON/OFF cycle, a semi-static configuration, or a dynamic configuration.

In some aspects, at 1704, the UE may receive an indication of the cell ON/OFF cycle. The ON cycle in the cell ON/OFF cycle may correspond to the downlink operator subband and the uplink operator subband. For example, referring to FIG. 16, the UE 1602 may, at 1616, receive an indication of the cell ON/OFF cycle. Referring to FIG. 15B, the ON cycle (e.g., ON duration 1552) in the cell ON/OFF cycle may correspond to the downlink operator subband and the uplink operator subband at 1532. In some aspects, 1704 may be performed by the spectrum sharing component 198.

In some aspects, the network sharing information may include one or more of: identifiers of the different core networks, spectrum sharing information among the different core networks, a spectrum sharing mode including a fixed spectrum sharing or a dynamic spectrum sharing, or time sharing information among the different core networks. For example, referring to FIG. 9, the network sharing information may include IDs of the different core networks (e.g., core network respectively associated with operator A 902, operator B 904, operator C 906, operator D 908) that sharing the component carrier 920.

In some aspects, the spectrum sharing information may include one or more of: a frequency division duplex (FDD) mode among the different core networks, a time division duplex (TDD) mode among the different core networks, or an SBFD mode among the different core networks. For example, referring to FIG. 9, FIG. 13, spectrum sharing information may include the FDD/paired mode in FIG. 9, TDD mode in FIG. 13, or an SBFD mode.

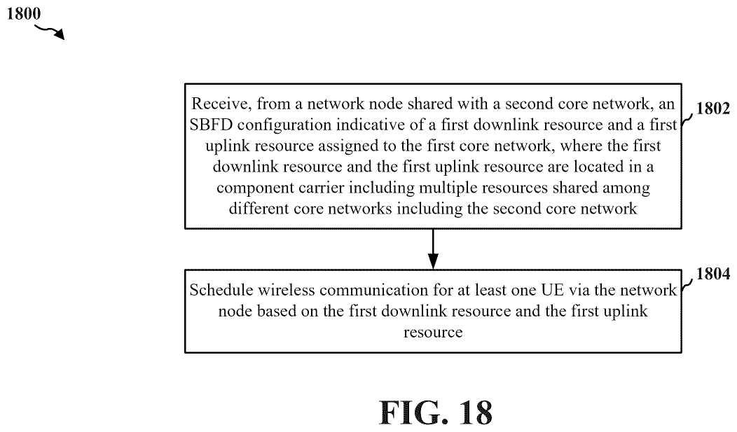

FIG. 18 is a flowchart 1800 illustrating methods of wireless communication at a first core network in accordance with various aspects of the present disclosure. The method may be performed by the first core network in collaboration with a UE and a network node. The network node may be a network entity, which may be a base station, or a component of a base station, in the access network of FIG. 1 or a core network component (e.g., base station 102, 310, RAN 1604; or the network entity 2102 in the hardware implementation of FIG. 21). The first core network may be core network 120, or the first core network 1606. The UE may be the UE 104, 350, 1602, or the apparatus 2104 in the hardware implementation of FIG. 21. By implementing interference mitigation in shared RAN setups, the methods enable effective mitigation of CLI between operators, which is traditionally hard to manage due to a lack of inter-operator coordination. Additionally, by assigning paired downlink and uplink subbands to each operator within a large shared component carrier, the methods enable full SBFD capability for each operator independently and effective mitigation of CLI between operators. In some examples, by enabling TDM and FDM sharing of a component carrier for multiple operators, the methods improve spectrum flexibility and adaptability.

As shown in FIG. 18, at 1802, the first core network may receive, from a network node shared with a second core network, an SBFD configuration indicative of a first downlink resource and a first uplink resource assigned to the first core network. The first downlink resource and the first uplink resource may be located in a component carrier including multiple resources shared among different core networks including the second core network. FIG. 9, FIG. 10, FIG. 11, FIG. 12, FIG. 13, FIG. 14A, FIG. 14B, FIG. 15A, FIG. 15B, and FIG. 16 illustrate various aspects of the steps in connection with flowchart 1800. For example, referring to FIG. 16, the first core network 1606 may, at 1610, receive, from a network node (e.g., RAN 1604) shared with a second core network 1608, an SBFD configuration indicative of a first downlink resource and a first uplink resource assigned to the first core network.

Referring to FIG. 9, the first core network may be associated with operator A 902, a first downlink resource (e.g., downlink operator subband 941) and the first uplink resource (e.g., uplink operator subband 942) may be located in a component carrier 920, which may include multiple resources shared among different core networks (e.g., core network respectively associated with operator A 902, operator B 904, operator C 906, operator D 908) including a second core network (e.g., core network associated with operator B 904). In some aspects, 1802 may be performed by the spectrum sharing component 199.

At 1804, the first core network may schedule wireless communication for at least one UE via the network node based on the first downlink resource and the first uplink resource. For example, referring to FIG. 16, the first core network 1606 may, at 1620, schedule wireless communication for UE 1602 via the network node (e.g., RAN 1604) based on the first downlink resource and the first uplink resource. In some aspects, 1804 may be performed by the spectrum sharing component 199.

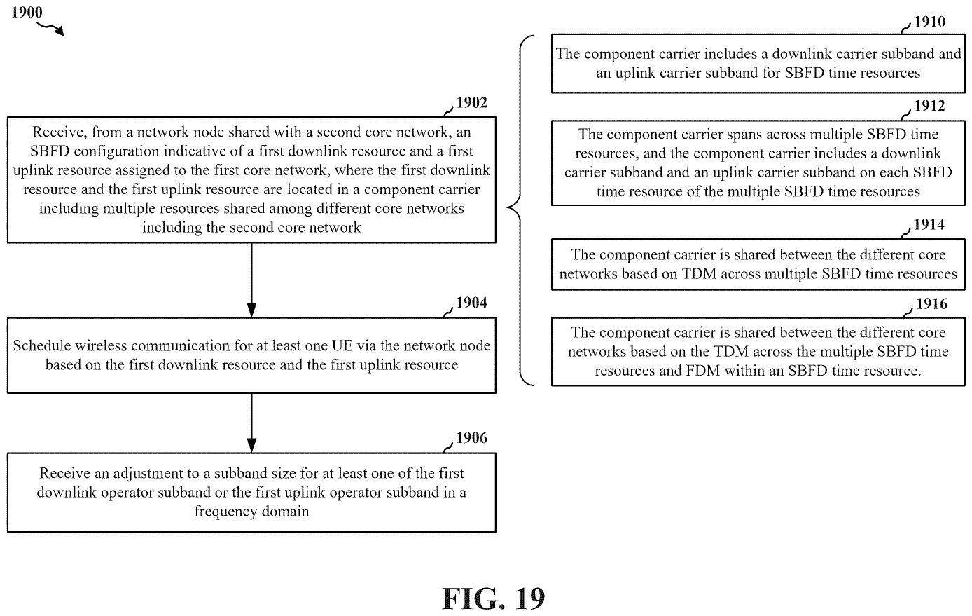

FIG. 19 is a flowchart 1900 illustrating methods of wireless communication at a first core network in accordance with various aspects of the present disclosure. The method may be performed by the first core network in collaboration with a UE and a network node. The network node may be a network entity, which may be a base station, or a component of a base station, in the access network of FIG. 1 or a core network component (e.g., base station 102, 310, RAN 1604; or the network entity 2102 in the hardware implementation of FIG. 21). The first core network may be core network 120, or the first core network 1606. The UE may be the UE 104, 350, 1602, or the apparatus 2104 in the hardware implementation of FIG. 21. By implementing interference mitigation in shared RAN setups, the methods enable effective mitigation of CLI between operators, which is traditionally hard to manage due to a lack of inter-operator coordination. Additionally, by assigning paired downlink and uplink subbands to each operator within a large shared component carrier, the methods enable full SBFD capability for each operator independently and effective mitigation of CLI between operators. In some examples, by enabling TDM and FDM sharing of a component carrier for multiple operators, the methods improve spectrum flexibility and adaptability.

As shown in FIG. 19, at 1902, the first core network may receive, from a network node shared with a second core network, an SBFD configuration indicative of a first downlink resource and a first uplink resource assigned to the first core network. The first downlink resource and the first uplink resource may be located in a component carrier including multiple resources shared among different core networks including the second core network. FIG. 9, FIG. 10, FIG. 11, FIG. 12, FIG. 13, FIG. 14A, FIG. 14B, FIG. 15A, FIG. 15B, and FIG. 16 illustrate various aspects of the steps in connection with flowchart 1900. For example, referring to FIG. 16, the first core network 1606 may, at 1610, receive, from a network node (e.g., RAN 1604) shared with a second core network 1608, an SBFD configuration indicative of a first downlink resource and a first uplink resource assigned to the first core network. Referring to FIG. 9, the first core network may be associated with operator A 902, a first downlink resource (e.g., downlink operator subband 941) and the first uplink resource (e.g., uplink operator subband 942) may be located in a component carrier 920, which may include multiple resources shared among different core networks (e.g., core network respectively associated with operator A 902, operator B 904, operator C 906, operator D 908) including a second core network (e.g., core network associated with operator B 904). In some aspects, 1902 may be performed by the spectrum sharing component 199.

At 1904, the first core network may schedule wireless communication for at least one UE via the network node based on the first downlink resource and the first uplink resource. For example, referring to FIG. 16, the first core network 1606 may, at 1620, schedule wireless communication for UE 1602 via the network node (e.g., RAN 1604) based on the first downlink resource and the first uplink resource. In some aspects, 1904 may be performed by the spectrum sharing component 199.

In some aspects, the component carrier may include a downlink carrier subband and an uplink carrier subband for SBFD time resources (e.g., at 1910). The first downlink resource includes a first downlink operator subband located in the downlink carrier subband, and the first uplink resource includes a first uplink operator subband located in the uplink carrier subband. For example, referring to FIG. 9, the component carrier 920 may include a downlink carrier subband 922 and an uplink carrier subband 924 for SBFD time resources. The first downlink resource includes a first downlink operator subband 941 located in the downlink carrier subband 922, and the first uplink resource includes a first uplink operator subband 942 located in the uplink carrier subband 924.

In some aspects, the downlink carrier subband may further include a second downlink operator subband and a second uplink operator subband for the second core network, and the first downlink operator subband does not overlap with the second downlink operator subband in a frequency domain, and the first uplink operator subband does not overlap with the second uplink operator subband in the frequency domain. For example, referring to FIG. 9, the downlink carrier subband 924 may further include a second downlink operator subband 943 and a second uplink operator subband 944 for the second core network (e.g., core network for operator B 904), and the first downlink operator subband 941 does not overlap with the second downlink operator subband 943 in a frequency domain, and the first uplink operator subband 942 does not overlap with the second uplink operator subband 944 in the frequency domain.

In some aspects, the first downlink operator subband and the first uplink operator subband may be associated with a first SBFD operation for the first core network, and the second downlink operator subband and the second uplink operator subband are associated with a second SBFD operation for the second core network. For example, referring to FIG. 9, the first downlink operator subband 941 and the first uplink operator subband 942 may be associated with a first SBFD operation for the first core network (e.g., e.g., operator A 902), and the second downlink operator subband 943 and the second uplink operator subband 944 are associated with a second SBFD operation for the second core network (e.g., operator B 904).

In some aspects, a first allocation of the first downlink operator subband in the downlink carrier subband and a second allocation of the first uplink operator subband in the uplink carrier subband may be based on one or more of: a fixed downlink subband and a fixed uplink subband, a semi-static configuration, or a dynamic configuration. For example, referring to FIG. 9, a first allocation of the first downlink operator subband 941 in the downlink carrier subband 922 and a second allocation of the first uplink operator subband 942 in the uplink carrier subband 924 may be based on one or more of: a fixed downlink subband and a fixed uplink subband, a semi-static configuration, or a dynamic configuration.

In some aspects, the first downlink resource may further include an additional downlink operator subband assigned to the first core network, and the additional downlink operator subband may be separated from the first downlink operator subband in a frequency domain. For example, referring to FIG. 11, the first downlink resource may further include an additional downlink operator subband (e.g., downlink operator subband 1147) assigned to the first core network, and the additional downlink operator subband (e.g., downlink operator subband 1147) may be separated from the first downlink operator subband 1141 in the frequency domain.

In some aspects, at 1906, the first core network may receive an adjustment to a subband size for at least one of the first downlink operator subband or the first uplink operator subband in a frequency domain. For example, referring to FIG. 16, the first core network 1606 may, at 1624, receive an adjustment to a subband size for at least one of the first downlink operator subband or the first uplink operator subband in the frequency domain. In some aspects, 1906 may be performed by the spectrum sharing component 199.

In some aspects, the component carrier may span across multiple SBFD time resources, and the component carrier may include a first carrier subband and a second carrier subband on each SBFD time resource of the multiple SBFD time resources (e.g., at 1912). The first carrier subband at a first SBFD time resource of the multiple SBFD time resources may be different from the first carrier subband at a second SBFD time resource of the multiple SBFD time resources in a frequency domain. For example, referring to FIG. 13, the component carrier 1320 may span across multiple SBFD time resources (e.g., 1330, 1332, 134, 1336, 1338), and the component carrier 1320 may include a first carrier subband 1322 and a second carrier subband 1324 on each SBFD time resource of the multiple SBFD time resources. The first carrier subband 1322 at a first SBFD time resource (e.g., at 1330) of the multiple SBFD time resources may be different from the first carrier subband at a second SBFD time resource (e.g., at 1336) of the multiple SBFD time resources in a frequency domain.

In some aspects, the first downlink resource may include a first downlink operator subband located on a first set of SBFD time resources in the multiple SBFD time resources, and the first uplink resource includes a first uplink operator subband located on a second set of SBFD time resources in the multiple SBFD time resources.

The first set of SBFD time resources may not overlap with the second set of SBFD time resources in the time domain. For example, referring to FIG. 13, the first downlink resource may include a first downlink operator subband 1342 located on a first set of SBFD time resources (e.g., at 1330) in the multiple SBFD time resources, and the first uplink resource includes a first uplink operator subband 1352 located on a second set of SBFD time resources (e.g., at 1336) in the multiple SBFD time resources. The first set of SBFD time resources (e.g., at 1330) may not overlap with the second set of SBFD time resources (e.g., at 1336) in the time domain.

In some aspects, the component carrier may be shared between the different core networks based on time division multiplex (TDM) across multiple SBFD time resources (e.g., at 1914). For example, referring to FIG. 14A, the component carrier 1420 may be shared between the different core networks based on TDM across multiple SBFD time resources. For example, the entire spectrum (e.g., downlink carrier subband 1422 and uplink carrier subband 1424) of component carrier 1420 may be assigned to operator A 1402 during time slot (e.g., symbol or slot) 1432, assigned to operator B 1404 during time slot (e.g., symbol or slot) 1434, and assigned to operator C 1406 during time slot (e.g., symbol or slot) 1436.

In some aspects, the component carrier may include a downlink carrier subband and an uplink carrier subband across the multiple SBFD time resources. The first downlink resource may be located within a first portion of the downlink carrier subband located in a first set of SBFD time resources in the multiple SBFD time resources, and the first uplink resource may be located within the first portion of the uplink carrier subband in the first set of SBFD time resources in the multiple SBFD time resources. A second downlink operator subband for the second core network may be located within a second portion of the downlink carrier subband located in a second set of SBFD time resources in the multiple SBFD time resources, and a second uplink operator subband for the second core network may be located within the second portion of the uplink carrier subband located in the second set of SBFD time resources. For example, referring to FIG. 14A, the component carrier 1420 may include a downlink carrier subband 1422 and an uplink carrier subband 1424 across the multiple SBFD time resources (e.g., 1432, 1434, 1436). The first downlink resource may be located within a first portion of the downlink carrier subband 1422 located in a first set of SBFD time resources (e.g., 1432) in the multiple SBFD time resources, and the first uplink resource may be located within the first portion of the uplink carrier subband 1424 in the first set of SBFD time resources (e.g., 1432) in the multiple SBFD time resources. A second downlink operator subband for the second core network may be located within a second portion of the downlink carrier subband 1422 located in a second set of SBFD time resources (e.g., 1434) in the multiple SBFD time resources, and a second uplink operator subband for the second core network may be located within the second portion of the uplink carrier subband 1424 located in the second set of SBFD time resources (e.g., 1434).

In some aspects, the distribution of a first set of SBFD time resources in the multiple SBFD time resources may be based on one or more of: a cell ON/OFF cycle, a semi-static configuration, or a dynamic configuration. For example, referring to FIG. 14A, the distribution of a first set of SBFD time resources (e.g., 1432) in the multiple SBFD time resources may be based on one or more of: a cell ON/OFF cycle, a semi-static configuration, or a dynamic configuration.

In some aspects, the component carrier may be shared between the different core networks based on the TDM across the multiple SBFD time resources and frequency division multiplexing (FDM) within an SBFD time resource (e.g., at 1916). For example, referring to FIG. 15A, the component carrier 1520 may be shared between the different core networks based on the TDM across the multiple SBFD time resources and FDM within an SBFD time resource.

In some aspects, a second downlink operator subband for the second core network may be located within a first portion of a downlink carrier subband, and a second uplink operator subband for the second core network may be located within the first portion of an uplink carrier subband. A third downlink operator subband for a third core network may be located within a second portion of the downlink carrier subband located in a second set of SBFD time resources in the multiple SBFD time resources, and a third uplink operator subband for the third core network may be located within the second portion of the uplink carrier subband located in the second set of SBFD time resources. For example, referring to FIG. 15A, a second downlink operator subband for the second core network (e.g., operator B 1504) may be located within a first portion of a downlink carrier subband 1522, and a second uplink operator subband for the second core network may be located within the first portion of an uplink carrier subband 1524. A third downlink operator subband for a third core network (e.g., operator C 1506) may be located within a second portion of the downlink carrier subband 1522 located in a second set of SBFD time resources (e.g., 1534) in the multiple SBFD time resources, and a third uplink operator subband for the third core network (e.g., operator C 1506) may be located within the second portion of the uplink carrier subband 1524 located in the second set of SBFD time resources (e.g., 1534).

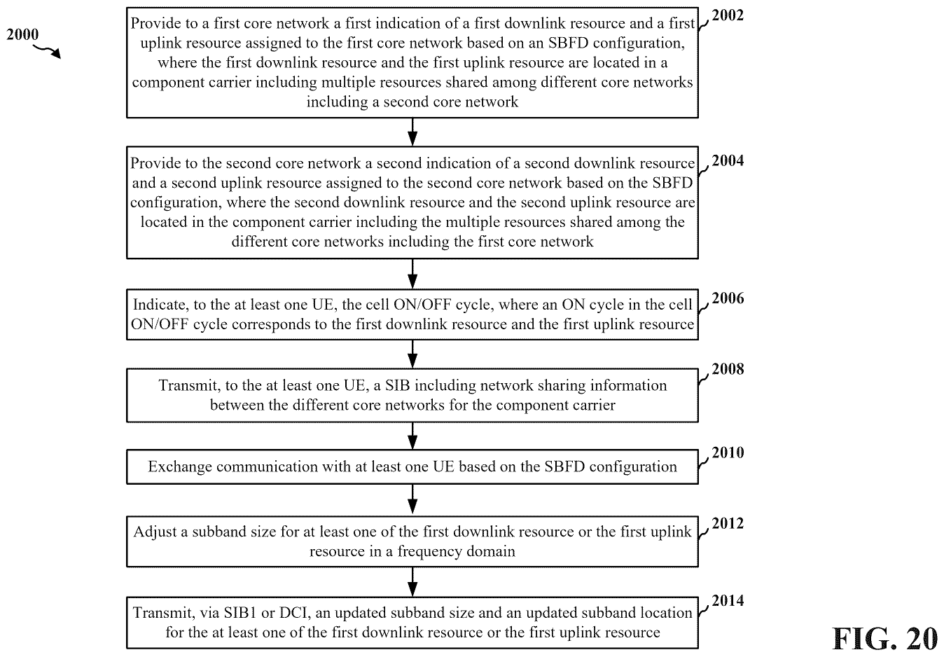

FIG. 20 is a flowchart 2000 illustrating methods of wireless communication at a network node shared by multiple core networks in accordance with various aspects of the present disclosure. The method may be performed by the network node in collaboration with a UE and a first core network. The network node may be a network entity, which may be a base station, or a component of a base station, in the access network of FIG. 1 or a core network component (e.g., base station 102, 310, RAN 1604; or the network entity 2102 in the hardware implementation of FIG. 21). The first core network may be core network 120, or the first core network 1606. The UE may be the UE 104, 350, 1602, or the apparatus 2104 in the hardware implementation of FIG. 21. By implementing interference mitigation in shared RAN setups, the methods enable effective mitigation of CLI between operators, which is traditionally hard to manage due to a lack of inter-operator coordination. Additionally, by assigning paired downlink and uplink subbands to each operator within a large shared component carrier, the methods enable full SBFD capability for each operator independently and effective mitigation of CLI between operators. In some examples, by enabling TDM and FDM sharing of a component carrier for multiple operators, the methods improve spectrum flexibility and adaptability.

As shown in FIG. 20, at 2002, the network node may provide to a first core network a first indication of a first downlink resource and a first uplink resource assigned to the first core network based on an SBFD configuration. The first downlink resource and the first uplink resource are located in a component carrier including multiple resources shared among different core networks including a second core network. FIG. 9, FIG. 10, FIG. 11, FIG. 12, FIG. 13, FIG. 14A, FIG. 14B, FIG. 15A, FIG. 15B, and FIG. 16 illustrate various aspects of the steps in connection with flowchart 2000. For example, referring to FIG. 16, the network node (e.g., RAN 1604) may, at 1610, provide to a first core network 1606 a first indication of a first downlink resource and a first uplink resource assigned to the first core network based on an SBFD configuration. Referring to FIG. 9, the first downlink resource (e.g., downlink operator subband 941) and the first uplink resource (e.g., uplink operator subband 942) are located in a component carrier 920 including multiple resources shared among different core networks including a second core network. In some aspects, 2002 may be performed by the spectrum sharing component 199.

At 2004, the network node may provide to the second core network a second indication of a second downlink resource and a second uplink resource assigned to the second core network based on the SBFD configuration. The second downlink resource and the second uplink resource may be located in the component carrier including the multiple resources shared among the different core networks including the first core network. For example, referring to FIG. 16, the network node (e.g., RAN 1604) may, at 1612, provide to the second core network 1608 a second indication of a second downlink resource (e.g., downlink operator subband 943) and a second uplink resource (e.g., uplink operator subband 944) assigned to the second core network based on the SBFD configuration. Referring to FIG. 9, the second downlink resource (e.g., downlink operator subband 943) and the second uplink resource (e.g., uplink operator subband 944) may be located in the component carrier 920 including the multiple resources shared among the different core networks including the first core network. In some aspects, 2004 may be performed by the spectrum sharing component 199.

At 2010, the network node may exchange communication with at least one UE based on the SBFD configuration. For example, referring to FIG. 16, the network node (e.g., RAN 1604) may, at 1618, exchange communication with UE 1602 based on the SBFD configuration. In some aspects, 2010 may be performed by the spectrum sharing component 199.

In some aspects, the component carrier may include multiple pairs of downlink and uplink subbands, and at least a first pair is allocated in a first allocation to the first core network and at least a second pair is allocated in a second allocation to the second core network. For example, referring to FIG. 9, the component carrier 920 may include multiple pairs of downlink and uplink subbands, and at least a first pair (e.g., downlink operator subband 941 and uplink operator subband 942) is allocated in a first allocation to the first core network (e.g., operator A 902) and at least a second pair (e.g., downlink operator subband 943 and uplink operator subband 944) is allocated in a second allocation to the second core network (e.g., operator B 904).

In some aspects, at least one of the first allocation or the second allocation may be based on one or more of: a fixed downlink subband and a fixed uplink subband, a semi-static configuration, or a dynamic configuration. For example, referring to FIG. 9, at least one of the first allocation (e.g., downlink operator subband 941 and uplink operator subband 942) or the second allocation (e.g., downlink operator subband 943 and uplink operator subband 944) may be based on one or more of: a fixed downlink subband and a fixed uplink subband, a semi-static configuration, or a dynamic configuration.

In some aspects, the first downlink resource may further include an additional downlink resource assigned to the first core network, wherein the additional downlink resource is separated from the first downlink resource in a frequency domain. For example, referring to FIG. 11, the first downlink resource may further include an additional downlink resource (e.g., downlink operator subband 1147) assigned to the first core network (e.g., operator A 1102), and the additional downlink resource (e.g., downlink operator subband 1147) is separated from the first downlink resource (e.g., downlink operator subband 1141) in the frequency domain.

In some aspects, at 2012, the network node may adjust a subband size for at least one of the first downlink resource or the first uplink resource in a frequency domain. For example, referring to FIG. 16, the network node (e.g., RAN 1604) may, at 1622, adjust a subband size for at least one of the first downlink resource or the first uplink resource in a frequency domain. In some aspects, 2012 may be performed by the spectrum sharing component 199.

In some aspects, at 2014, the network node may transmit, via system information block type 1 (SIB1) or DCI, an updated subband size and an updated subband location for the at least one of the first downlink resource or the first uplink resource. For example, referring to FIG. 16, the network node (e.g., RAN 1604) may, at 1628, transmit, via SIB1 or DCI, an updated subband size and an updated subband location for the at least one of the first downlink resource or the first uplink resource. In some aspects, 2014 may be performed by the spectrum sharing component 199.

In some aspects, at least one of an uplink operator subband or a downlink operator subband may be different across different SBFD time resources. For example, referring to FIG. 13, the uplink operator subband at 1330 is different from the uplink operator subband at 1336.

In some aspects, a core network may be allocated the downlink operator subband or the uplink operator subband in different time resources based on time division duplex (TDD), the resources for different operators may be allocated based on frequency division multiplexing (FDM) in a same time resource. For example, referring to FIG. 13, a core network (e.g., operator A 1302) may be allocated the downlink operator subband (e.g., downlink operator subband 1342 at 1330) or the uplink operator subband (e.g., downlink operator subband 1342 at 1336) in different time resources based on TDD, the resources for different operators (e.g., operator A 1302, operator B 1304, operator C 1306) may be allocated based on FDM in the same time resource.

In some aspects, the component carrier may be shared between the different core networks based on TDM across multiple SBFD time resources. For example, referring to FIG. 14A, the component carrier 1420 may be shared between the different core networks (e.g., operator A 1402, operator B 1404, operator C 1406) based on TDM across multiple SBFD time resources (e.g., 1432, 1434, 1436).

In some aspects, the distribution for the TDM may be based on one or more of: a cell ON/OFF cycle, a semi-static configuration, or a dynamic configuration. For example, referring to FIG. 14A, the distribution for the TDM for component carrier 1420 may be based on one or more of: a cell ON/OFF cycle, a semi-static configuration, or a dynamic configuration.

In some aspects, at 2006, the network node may indicate, to the at least one UE, the cell ON/OFF cycle. The ON cycle in the cell ON/OFF cycle may correspond to the first downlink resource and the first uplink resource. For example, referring to FIG. 16, the network node (e.g., RAN 1604) may, at 1616, indicate, to UE 1602, the cell ON/OFF cycle. The ON cycle in the cell ON/OFF cycle may correspond to the first downlink resource and the first uplink resource. In some aspects, 2006 may be performed by the spectrum sharing component 199.

In some aspects, the component carrier may be shared between the different core networks based on TDM across multiple SBFD time resources and FDM within an SBFD time resource. For example, referring to FIG. 15A, the component carrier 1520 may be shared between the different core networks (e.g., operator A 1502, operator B 1504, operator C 1506, operator D 1508) based on TDM across multiple SBFD time resources and FDM within an SBFD time resource.

In some aspects, at 2008, the network node may transmit, to the at least one UE, a system information block (SIB) including network sharing information between the different core networks for the component carrier. For example, referring to FIG. 16, the network node (e.g., RAN 1604) may, at 1614, transmit, to UE 1602, a SIB including network sharing information between the different core networks for the component carrier. In some aspects, 2008 may be performed by the spectrum sharing component 199.

In some aspects, the network sharing information may include one or more of: identifiers of the different core networks, spectrum sharing information among the different core networks, a spectrum sharing mode including a fixed spectrum sharing or a dynamic spectrum sharing, or time sharing information among the different core networks. For example, referring to FIG. 16, the network sharing information (e.g., at 1614) may include one or more of: identifiers of the different core networks, spectrum sharing information among the different core networks, a spectrum sharing mode including a fixed spectrum sharing or a dynamic spectrum sharing, or time sharing information among the different core networks.

In some aspects, the spectrum sharing information may include one or more of: a FDD mode among the different core networks, a TDD mode among the different core networks, or an SBFD mode among the different core networks. For example, the spectrum sharing information may include the FDD/paired mode in FIG. 9, TDD mode in FIG. 13, or an SBFD mode.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include at least one cellular baseband processor (or processing circuitry) 2124 (also referred to as a modem) coupled to one or more transceivers 2122 (e.g., cellular RF transceiver). The cellular baseband processor(s) (or processing circuitry) 2124 may include at least one on-chip memory (or memory circuitry) 2124′. In some aspects, the apparatus 2104 may further include one or more subscriber identity modules (SIM) cards 2120 and at least one application processor (or processing circuitry) 2106 coupled to a secure digital (SD) card 2108 and a screen 2110. The application processor(s) (or processing circuitry) 2106 may include on-chip memory (or memory circuitry) 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor(s) (or processing circuitry) 2124 communicates through the transceiver(s) 2122 via one or more antennas 2180 with the UE 104 and/or with an RU associated with a network entity 2102. The cellular baseband processor(s) (or processing circuitry) 2124 and the application processor(s) (or processing circuitry) 2106 may each include a computer-readable medium/memory (or memory circuitry) 2124′, 2106′, respectively. The additional memory modules 2126 may also be considered a computer-readable medium/memory (or memory circuitry). Each computer-readable medium/memory (or memory circuitry) 2124′, 2106′, 2126 may be non-transitory. The cellular baseband processor(s) (or processing circuitry) 2124 and the application processor(s) (or processing circuitry) 2106 are each responsible for general processing, including the execution of software stored on the computer-readable medium/memory (or memory circuitry). The software, when executed by the cellular baseband processor(s) (or processing circuitry) 2124/application processor(s) (or processing circuitry) 2106, causes the cellular baseband processor(s) (or processing circuitry) 2124/application processor(s) (or processing circuitry) 2106 to perform the various functions described supra. The cellular baseband processor(s) (or processing circuitry) 2124 and the application processor(s) (or processing circuitry) 2106 are configured to perform the various functions described supra based at least in part of the information stored in the memory (or memory circuitry). That is, the cellular baseband processor(s) (or processing circuitry) 2124 and the application processor(s) (or processing circuitry) 2106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 2124/application processor(s) (or processing circuitry) 2106 when executing software. The cellular baseband processor(s) (or processing circuitry) 2124/application processor(s) (or processing circuitry) 2106 may be a component of the UE 350 and may include the at least one memory 360 and/or at least one of the TX processor 368, the RX processor 356, and the controller/processor 359. In one configuration, the apparatus 2104 may be at least one processor chip (modem and/or application) and include just the cellular baseband processor(s) (or processing circuitry) 2124 and/or the application processor(s) (or processing circuitry) 2106, and in another configuration, the apparatus 2104 may be the entire UE (e.g., see UE 350 of FIG. 3) and include the additional modules of the apparatus 2104.

As discussed supra, the component 198 may be configured to receive, from a network node, SIB including network sharing information for a component carrier between different core networks including a first core network, where the network sharing information indicates a downlink operator subband and an uplink operator subband for the first core network that serves the UE, where the downlink operator subband and the uplink operator subband are located in the component carrier comprising multiple resources shared among the different core networks; and communicate with the first core network based on the downlink operator subband and the uplink operator subband. The component 198 may be further configured to perform any of the aspects described in connection with the flowchart in FIG. 17, and/or performed by the UE 1602 in FIG. 16. The component 198 may be within the cellular baseband processor(s) (or processing circuitry) 2124, the application processor(s) (or processing circuitry) 2106, or both the cellular baseband processor(s) (or processing circuitry) 2124 and the application processor(s) (or processing circuitry) 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2104 may include a variety of components configured for various functions. In one configuration, the apparatus 2104, and in particular the cellular baseband processor(s) (or processing circuitry) 2124 and/or the application processor(s) (or processing circuitry) 2106, includes means for receiving, from a network node, SIB including network sharing information for a component carrier between different core networks including a first core network, where the network sharing information indicates a downlink operator subband and an uplink operator subband for the first core network that serves the UE, where the downlink operator subband and the uplink operator subband are located in the component carrier comprising multiple resources shared among the different core networks; and means for communicating with the first core network based on the downlink operator subband and the uplink operator subband. The apparatus 2104 may further include means for performing any of the aspects described in connection with the flowchart in FIG. 17, and/or aspects performed by the UE 1602 in FIG. 16. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

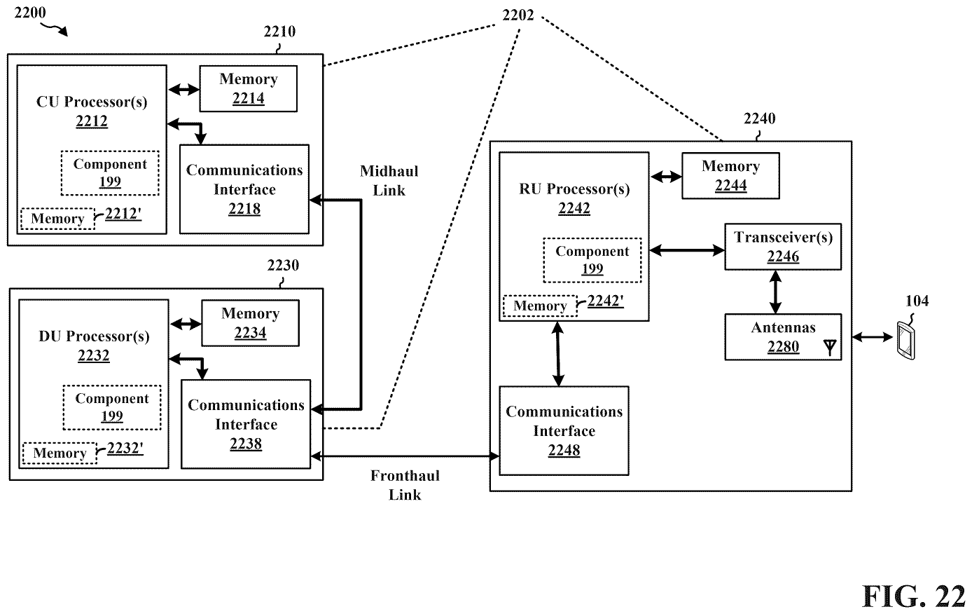

FIG. 22 is a diagram 2200 illustrating an example of a hardware implementation for a network entity 2202. The network entity 2202 may be a BS, a component of a BS, or may implement BS functionality. The network entity 2202 may include at least one of a CU 2210, a DU 2230, or an RU 2240. For example, depending on the layer functionality handled by the component 199, the network entity 2202 may include the CU 2210; both the CU 2210 and the DU 2230; each of the CU 2210, the DU 2230, and the RU 2240; the DU 2230; both the DU 2230 and the RU 2240; or the RU 2240. The CU 2210 may include at least one CU processor (or processing circuitry) 2212. The CU processor(s) (or processing circuitry) 2212 may include on-chip memory (or memory circuitry) 2212′. In some aspects, the CU 2210 may further include additional memory modules 2214 and a communications interface 2218. The CU 2210 communicates with the DU 2230 through a midhaul link, such as an F1 interface. The DU 2230 may include at least one DU processor (or processing circuitry) 2232. The DU processor(s) (or processing circuitry) 2232 may include on-chip memory (or memory circuitry) 2232′. In some aspects, the DU 2230 may further include additional memory modules 2234 and a communications interface 2238. The DU 2230 communicates with the RU 2240 through a fronthaul link. The RU 2240 may include at least one RU processor (or processing circuitry) 2242. The RU processor(s) (or processing circuitry) 2242 may include on-chip memory (or memory circuitry) 2242′. In some aspects, the RU 2240 may further include additional memory modules 2244, one or more transceivers 2246, antennas 2280, and a communications interface 2248. The RU 2240 communicates with the UE 104. The on-chip memory (or memory circuitry) 2212′, 2232′, 2242′ and the additional memory modules 2214, 2234, 2244 may each be considered a computer-readable medium/memory (or memory circuitry). Each computer-readable medium/memory (or memory circuitry) may be non-transitory. Each of the processors (or processing circuitry) 2212, 2232, 2242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, in some aspects, the component 199 may be configured to receive, from a network node shared with a second core network, an SBFD configuration indicative of a first downlink resource and a first uplink resource assigned to the first core network, where the first downlink resource and the first uplink resource are located in a component carrier comprising multiple resources shared among different core networks including the second core network; and schedule wireless communication for at least one UE via the network node based on the first downlink resource and the first uplink resource. In some aspects, the component 199 may be configured to provide to a first core network a first indication of a first downlink resource and a first uplink resource assigned to the first core network based on an SBFD configuration, where the first downlink resource and the first uplink resource are located in a component carrier including multiple resources shared among different core networks including a second core network; provide to the second core network a second indication of a second downlink resource and a second uplink resource assigned to the second core network based on the SBFD configuration, where the second downlink resource and the second uplink resource are located in the component carrier comprising the multiple resources shared among the different core networks including the first core network; and exchange communication with at least one UE based on the SBFD configuration. The component 199 may be further configured to perform any of the aspects described in connection with the flowcharts in FIG. 18, FIG. 19, and FIG. 20, and/or performed by the RAN 1604 in FIG. 16. The component 199 may be within one or more processors (or processing circuitry) of one or more of the CU 2210, DU 2230, and the RU 2240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2202 may include a variety of components configured for various functions. In one configuration, the network entity 2202 includes means for receiving, from a network node shared with a second core network, an SBFD configuration indicative of a first downlink resource and a first uplink resource assigned to the first core network, where the first downlink resource and the first uplink resource are located in a component carrier comprising multiple resources shared among different core networks including the second core network; and means for scheduling wireless communication for at least one UE via the network node based on the first downlink resource and the first uplink resource. In one configuration, the network entity 2202 includes means for providing to a first core network a first indication of a first downlink resource and a first uplink resource assigned to the first core network based on an SBFD configuration, where the first downlink resource and the first uplink resource are located in a component carrier including multiple resources shared among different core networks including a second core network; means for providing to the second core network a second indication of a second downlink resource and a second uplink resource assigned to the second core network based on the SBFD configuration, where the second downlink resource and the second uplink resource are located in the component carrier comprising the multiple resources shared among the different core networks including the first core network; and means for exchanging communication with at least one UE based on the SBFD configuration. The network entity 2202 may further include means for performing any of the aspects described in connection with the flowcharts in FIG. 18, FIG. 19, and FIG. 20, and/or aspects performed by the RAN 1604 in FIG. 16. The means may be the component 199 of the network entity 2202 configured to perform the functions recited by the means. As described supra, the network entity 2202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first core network. The method may include receiving, from a network node shared with a second core network, an SBFD configuration indicative of a first downlink resource and a first uplink resource assigned to the first core network, where the first downlink resource and the first uplink resource are located in a component carrier comprising multiple resources shared among different core networks including the second core network; and scheduling wireless communication for at least one UE via the network node based on the first downlink resource and the first uplink resource. By implementing interference mitigation in shared RAN setups, the methods enable effective mitigation of CLI between operators, which is traditionally hard to manage due to a lack of inter-operator coordination. Additionally, by assigning paired downlink and uplink subbands to each operator within a large shared component carrier, the methods enable full SBFD capability for each operator independently and effective mitigation of CLI between operators. In some examples, by enabling TDM and FDM sharing of a component carrier for multiple operators, the methods improve spectrum flexibility and adaptability.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first core network, wherein the method includes receiving, from a network node shared with a second core network, a subband full duplex (SBFD) configuration indicative of a first downlink resource and a first uplink resource assigned to the first core network, wherein the first downlink resource and the first uplink resource are located in a component carrier comprising multiple resources shared among different core networks including the second core network; and scheduling wireless communication for at least one user equipment (UE) via the network node based on the first downlink resource and the first uplink resource.

Aspect 2 is the method of aspect 1, wherein the component carrier includes a downlink carrier subband and an uplink carrier subband for SBFD time resources, and wherein the first downlink resource includes a first downlink operator subband located in the downlink carrier subband, and the first uplink resource includes a first uplink operator subband located in the uplink carrier subband.

Aspect 3 is the method of aspect 2, wherein the downlink carrier subband further includes a second downlink operator subband and a second uplink operator subband for the second core network, and wherein the first downlink operator subband does not overlap with the second downlink operator subband in a frequency domain, and the first uplink operator subband does not overlap with the second uplink operator subband in the frequency domain.

Aspect 4 is the method of any of aspects 2 to 3, wherein the first downlink operator subband and the first uplink operator subband are associated with a first SBFD operation for the first core network, and the second downlink operator subband and the second uplink operator subband are associated with a second SBFD operation for the second core network.

Aspect 5 is the method of aspect 2, wherein a first allocation of the first downlink operator subband in the downlink carrier subband, and a second allocation of the first uplink operator subband in the uplink carrier subband are based on one or more of: a fixed downlink subband and a fixed uplink subband; a semi-static configuration; or a dynamic configuration.

Aspect 6 is the method of any of aspects 2 to 5, wherein the first downlink resource further includes an additional downlink operator subband assigned to the first core network, wherein the additional downlink operator subband is separated from the first downlink operator subband in a frequency domain.

Aspect 7 is the method of aspect 2, wherein the method further includes receiving an adjustment to a subband size for at least one of the first downlink operator subband or the first uplink operator subband in a frequency domain.

Aspect 8 is the method of aspect 1, wherein the component carrier spans across multiple SBFD time resources, and the component carrier includes a first carrier subband and a second carrier subband on each SBFD time resource of the multiple SBFD time resources, wherein the first carrier subband at a first SBFD time resource of the multiple SBFD time resources is different from the first carrier subband at a second SBFD time resource of the multiple SBFD time resources in a frequency domain.

Aspect 9 is the method of aspect 8, wherein the first downlink resource includes a first downlink operator subband located on a first set of SBFD time resources in the multiple SBFD time resources, and the first uplink resource includes a first uplink operator subband located on a second set of SBFD time resources in the multiple SBFD time resources, wherein the first set of SBFD time resources does not overlap with the second set of SBFD time resources in a time domain.

Aspect 10 is the method of any of aspects 1 to 7, wherein the component carrier is shared between the different core networks based on time division multiplex (TDM) across multiple SBFD time resources.

Aspect 11 is the method of aspect 10, wherein the component carrier includes a downlink carrier subband and an uplink carrier subband across the multiple SBFD time resources, and wherein the first downlink resource is located within a first portion of the downlink carrier subband located in a first set of SBFD time resources in the multiple SBFD time resources, and the first uplink resource is located within the first portion of the uplink carrier subband in the first set of SBFD time resources in the multiple SBFD time resources, and wherein a second downlink operator subband for the second core network is located within a second portion of the downlink carrier subband located in a second set of SBFD time resources in the multiple SBFD time resources, and a second uplink operator subband for the second core network is located within the second portion of the uplink carrier subband located in the second set of SBFD time resources.

Aspect 12 is the method of aspect 10, wherein a distribution of a first set of SBFD time resources in the multiple SBFD time resources is based on one or more of: a cell ON/OFF cycle; a semi-static configuration; or a dynamic configuration.

Aspect 13 is the method of aspect 10, wherein the component carrier is shared between the different core networks based on the TDM across the multiple SBFD time resources and frequency division multiplexing (FDM) within an SBFD time resource.

Aspect 14 is the method of aspect 13, wherein a second downlink operator subband for the second core network is located within a first portion of a downlink carrier subband, and a second uplink operator subband for the second core network is located within the first portion of an uplink carrier subband, and wherein a third downlink operator subband for a third core network is located within a second portion of the downlink carrier subband located in a second set of SBFD time resources in the multiple SBFD time resources, and a third uplink operator subband for the third core network is located within the second portion of the uplink carrier subband located in the second set of SBFD time resources.

Aspect 15 is an apparatus for wireless communication at a first core network, comprising: at least one memory; and at least one processor coupled to the at least one memory, the at least one processor is configured to perform the method of any of aspects 1 to 14.

Aspect 16 is the apparatus for wireless communication at a first core network, comprising means for performing each step in the method of any of aspects 1-14.

Aspect 17 is an apparatus of any of aspects 15-16, further comprising a transceiver configured to receive or to transmit in association with the method of any of aspects 1-14.

Aspect 18 is a computer-readable medium (e.g., a non-transitory computer-readable medium) storing computer executable code at a first core network, the code when executed by at least one processor causes the at least one processor to perform the method of any of aspects 1-14.

Aspect 19 is a method of wireless communication at a network node shared by multiple core networks, wherein the method includes providing to a first core network a first indication of a first downlink resource and a first uplink resource assigned to the first core network based on a subband full duplex (SBFD) configuration, wherein the first downlink resource and the first uplink resource are located in a component carrier comprising multiple resources shared among different core networks including a second core network; providing to the second core network a second indication of a second downlink resource and a second uplink resource assigned to the second core network based on the SBFD configuration, wherein the second downlink resource and the second uplink resource are located in the component carrier comprising the multiple resources shared among the different core networks including the first core network; and exchange communication with at least one user equipment (UE) based on the SBFD configuration.

Aspect 20 is the method of aspect 19, wherein the component carrier includes multiple pairs of downlink and uplink subbands, wherein at least a first pair is allocated in a first allocation to the first core network and at least a second pair is allocated in a second allocation to the second core network.

Aspect 21 is the method of aspect 20, wherein at least one of the first allocation or the second allocation is based on one or more of: a fixed downlink subband and a fixed uplink subband; a semi-static configuration; or a dynamic configuration.

Aspect 22 is the method of any of aspects 19 to 21, wherein the first downlink resource further includes an additional downlink resource assigned to the first core network, wherein the additional downlink resource is separated from the first downlink resource in a frequency domain.

Aspect 23 is the method of any of aspects 19 to 22, wherein the method further includes adjusting a subband size for at least one of the first downlink resource or the first uplink resource in a frequency domain.

Aspect 24 is the method of aspect 23, wherein the method further includes transmitting, via system information block type 1 (SIB1) or downlink control information (DCI), an updated subband size and an updated subband location for the at least one of the first downlink resource or the first uplink resource.

Aspect 25 is the method of aspect 19, wherein at least one of an uplink operator subband or a downlink operator subband is different across different SBFD time resources.

Aspect 26 is the method of aspect 25, wherein a core network is allocated the downlink operator subband or the uplink operator subband in different time resources based on time division duplex (TDD), wherein resources for different operators are allocated based on frequency division multiplexing (FDM) in a same time resource.

Aspect 27 is the method of aspect 19, wherein the component carrier is shared between the different core networks based on time division multiplexing (TDM) across multiple SBFD time resources.

Aspect 28 is the method of aspect 27, wherein a distribution for the TDM is based on one or more of: a cell ON/OFF cycle; a semi-static configuration; or a dynamic configuration.

Aspect 29 is the method of aspect 28, wherein the method further includes indicating, to the at least one UE, the cell ON/OFF cycle, wherein an ON cycle in the cell ON/OFF cycle corresponds to the first downlink resource and the first uplink resource.

Aspect 30 is the method of aspect 19, wherein the component carrier is shared between the different core networks based on time division multiplexing (TDM) across multiple SBFD time resources and frequency division multiplexing (FDM) within an SBFD time resource.

Aspect 31 is the method of any of aspects 19 to 30, wherein the method further includes transmitting, to the at least one UE, a system information block (SIB) comprising network sharing information between the different core networks for the component carrier.

Aspect 32 is the method of aspect 31, wherein the network sharing information includes one or more of: identifiers of the different core networks; spectrum sharing information among the different core networks; a spectrum sharing mode including a fixed spectrum sharing or a dynamic spectrum sharing; or time sharing information among the different core networks.

Aspect 33 is the method of aspect 32, wherein the spectrum sharing information includes one or more of: a frequency division duplex (FDD) mode among the different core networks; a time division duplex (TDD) mode among the different core networks; or an SBFD mode among the different core networks.

Aspect 34 is an apparatus for wireless communication at a network node shared by multiple core networks, comprising: at least one memory; and at least one processor coupled to the at least one memory and, where the at least one processor is configured to perform the method of any of aspects 19-33.

Aspect 35 is the apparatus for wireless communication at a network node shared by multiple core networks, comprising means for performing each step in the method of any of aspects 19-33.

Aspect 36 is an apparatus of any of aspects 34-35, further comprising a transceiver configured to receive or to transmit in association with the method of any of aspects 19-33.

Aspect 37 is a computer-readable medium (e.g., a non-transitory computer-readable medium) storing computer executable code at a network node shared by multiple core networks, the code when executed by at least one processor causes the at least one processor to perform the method of any of aspects 19-33.

Aspect 38 is a method of wireless communication at a user equipment (UE), wherein the method includes receiving, from a network node, system information block (SIB) comprising network sharing information for a component carrier between different core networks including a first core network, wherein the network sharing information indicates a downlink operator subband and an uplink operator subband for the first core network that serves the UE, wherein the downlink operator subband and the uplink operator subband is located in the component carrier comprising multiple resources shared among the different core networks; and communicating with the first core network based on the downlink operator subband and the uplink operator subband.

Aspect 39 is the method of aspect 38, wherein the method further includes receiving, via system information block type 1 (SIB1) or downlink control information (DCI), an updated subband size and an updated subband location for the at least one of the downlink operator subband or the uplink operator subband.

Aspect 40 is the method of aspect 38, wherein the component carrier is shared between the different core networks based on time division multiplexing (TDM) across multiple SBFD time resources and a distribution for the TDM is based on one or more of a cell ON/OFF cycle; a semi-static configuration; or a dynamic configuration.

Aspect 41 is the method of aspect 40, wherein the method further includes receiving an indication of the cell ON/OFF cycle, wherein an ON cycle in the cell ON/OFF cycle corresponds to the downlink operator subband and the uplink operator subband.

Aspect 42 is the method of any of aspects 38 to 41, wherein the network sharing information includes one or more of: identifiers of the different core networks; spectrum sharing information among the different core networks; a spectrum sharing mode including a fixed spectrum sharing or a dynamic spectrum sharing; or time sharing information among the different core networks.

Aspect 43 is the method of aspect 42, wherein the spectrum sharing information includes one or more of: a frequency division duplex (FDD) mode among the different core networks; a time division duplex (TDD) mode among the different core networks; or an SBFD mode among the different core networks.

Aspect 44 is an apparatus for wireless communication at a UE, comprising: at least one memory; and at least one processor coupled to the at least one memory and, where the at least one processor is configured to perform the method of any of aspects 38-43.

Aspect 45 is the apparatus for wireless communication at a UE, comprising means for performing each step in the method of any of aspects 38-43.

Aspect 46 is an apparatus of any of aspects 44-45, further comprising a transceiver configured to receive or to transmit in association with the method of any of aspects 38-43.

Aspect 47 is a computer-readable medium (e.g., a non-transitory computer-readable medium) storing computer executable code at a UE, the code when executed by at least one processor causes the at least one processor to perform the method of any of aspects 39-44.

What is claimed is:

1. An apparatus for wireless communication at a network node shared by multiple core networks, comprising:
at least one memory; and
at least one processor coupled to the at least one memory and, based at least in part on information stored in the at least one memory, the at least one processor is configured to:
provide to a first core network a first indication of a first downlink resource and a first uplink resource assigned to the first core network based on a subband full duplex (SBFD) configuration, wherein the first downlink resource and the first uplink resource are located in a component carrier comprising multiple resources shared among different core networks including a second core network;
provide to the second core network a second indication of a second downlink resource and a second uplink resource assigned to the second core network based on the SBFD configuration, wherein the second downlink resource and the second uplink resource are located in the component carrier comprising the multiple resources shared among the different core networks including the first core network; and
exchange communication with at least one user equipment (UE) based on the SBFD configuration.

2. The apparatus of claim 1, further comprising a transceiver coupled to the at least one processor, wherein exchange communication with at least one UE, the at least one processor is configured to exchange communication with at least one UE via the transceiver, wherein the component carrier includes multiple pairs of downlink and uplink operator subbands, wherein at least a first pair is allocated in a first allocation to the first core network and at least a second pair is allocated in a second allocation to the second core network.

3. The apparatus of claim 2, wherein at least one of the first allocation or the second allocation is based on one or more of:
a fixed downlink subband and a fixed uplink subband,
a semi-static configuration, or
a dynamic configuration.

4. The apparatus of claim 1, wherein the first downlink resource further includes an additional downlink resource assigned to the first core network, wherein the additional downlink resource is separated from the first downlink resource in a frequency domain.

5. The apparatus of claim 1, wherein the at least one processor is further configured to:
adjust a subband size for at least one of the first downlink resource or the first uplink resource in a frequency domain.

6. The apparatus of claim 5, wherein the at least one processor is further configured to:
transmit, via system information block type 1 (SIB1) or downlink control information (DCI), an updated subband size and an updated subband location for the at least one of the first downlink resource or the first uplink resource.

7. The apparatus of claim 1, wherein at least one of an uplink operator subband or a downlink operator subband is different across different SBFD time resources.

8. The apparatus of claim 7, wherein a core network is allocated the downlink operator subband or the uplink operator subband in different time resources based on time division duplex (TDD), wherein resources for different operators are allocated based on frequency division multiplexing (FDM) in a same time resource.

9. The apparatus of claim 1, wherein the component carrier is shared between the different core networks based on time division multiplexing (TDM) across multiple SBFD time resources.

10. The apparatus of claim 9, wherein a distribution for the TDM is based on one or more of:
a cell ON/OFF cycle,
a semi-static configuration, or
a dynamic configuration.

11. The apparatus of claim 10, wherein the at least one processor is further configured to:
indicate, to the at least one UE, the cell ON/OFF cycle, wherein an ON cycle in the cell ON/OFF cycle corresponds to the first downlink resource and the first uplink resource.

12. The apparatus of claim 11, wherein the component carrier is shared between the different core networks based on time division multiplexing (TDM) across multiple SBFD time resources and frequency division multiplexing (FDM) within an SBFD time resource.

13. The apparatus of claim 1, wherein the at least one processor is further configured to:
transmit, to the at least one UE, a system information block (SIB) comprising network sharing information between the different core networks for the component carrier.

14. The apparatus of claim 13, wherein the network sharing information includes one or more of:
identifiers of the different core networks,
spectrum sharing information among the different core networks,
a spectrum sharing mode including a fixed spectrum sharing or a dynamic spectrum sharing, or
time sharing information among the different core networks.

15. The apparatus of claim 14, wherein the spectrum sharing information includes one or more of:
a frequency division duplex (FDD) mode among the different core networks,
a time division duplex (TDD) mode among the different core networks, or
an SBFD mode among the different core networks.

16. An apparatus for wireless communication at a user equipment (UE), comprising:
at least one memory; and
at least one processor coupled to the at least one memory and, based at least in part on information stored in the at least one memory, the at least one processor is configured to:
receive, from a network node, system information block (SIB) comprising network sharing information for a component carrier between different core networks including a first core network, wherein the network sharing information indicates a downlink operator subband and an uplink operator subband for the first core network that serves the UE, wherein the downlink operator subband and the uplink operator subband are located in the component carrier comprising multiple resources shared among the different core networks; and
communicate with the first core network based on the downlink operator subband and the uplink operator subband.

17. The apparatus of claim 16, further comprising a transceiver coupled to the at least one processor, wherein to receive the SIB, the at least one processor is configured to receive the SIB via the transceiver, wherein the at least one processor is further configured to:
receive, via system information block type 1 (SIB1) or downlink control information (DCI), an updated subband size and an updated subband location for the at least one of the downlink operator subband or the uplink operator subband.

18. The apparatus of claim 16, wherein the component carrier is shared between the different core networks based on time division multiplexing (TDM) across multiple SBFD time resources and a distribution for the TDM is based on one or more of a cell ON/OFF cycle, a semi-static configuration, or a dynamic configuration.

19. The apparatus of claim 18, wherein the at least one processor is further configured to:
receive an indication of the cell ON/OFF cycle, wherein an ON cycle in the cell ON/OFF cycle corresponds to the downlink operator subband and the uplink operator subband.

20. The apparatus of claim 16, wherein the network sharing information includes one or more of:
identifiers of the different core networks,
spectrum sharing information among the different core networks,
a spectrum sharing mode including a fixed spectrum sharing or a dynamic spectrum sharing, or
time sharing information among the different core networks.
